(19) United States
(12) Patent Application Publication
(10) Pub. No.: US 2011/0304138 A1
(43) Pub. Date: Dec. 15, 2011

(54) Extended flange plumbing for deep-sea oil containment

(76) Inventor: Frederic G. Commoner, Brighton, MA (US)

(21) Appl. No.: 13/134,221

(22) Filed: Jun. 1, 2011

Related U.S. Application Data
(60) Provisional application No. 61/397,288, filed on Jun. 9, 2010.

(51) Int. Cl. F16L 23/00; F16L 21/02

(52) U.S. Cl. 285/368; 285/378

(57) ABSTRACT

An emergency redundant mounting flange is provided for incorporation into an oil-well blow-out-preventer (BOP), enabling rapid, tight-fitting attachment of an oil containment cap over a BOP outflow port in an emergency. This flange extends radially outward from the protected port, and includes an annular region with a connection feature, such as a ring of bolt-holes, permitting cap attachment. The cap, also provided, is a barrel-shaped diameter-reduction pipe which can be connected onto the emergency mounting flange at its bottom end, and onto a standard riser pipe at its top end, thus containing or stopping the flow of oil. After installation, the cap fully encloses the protected port, while creating a tight seal with the emergency mounting flange. Extension of these methods to bell-and-spigot plumbing fixtures, including reinforced concrete pipe, is also provided.

### CROSS-REFERENCE TO RELATED APPLICATIONS

This application claims the benefit of provisional patent application Ser. No. 61/397,288, filed on Jun. 9, 2010 by the present inventor.

### FIELD OF THE INVENTION

The present invention relates to the containment of oil-leaks from blown-out oil wells, and, more particularly, to the attachment of an oil-containment cap to a leaking oil well by means of an extended flange fixture incorporated into the blow-out preventer.

### REFERENCE DOCUMENTS

[Cameron] “Considering Technical Options for controlling the BP blowout in the Gulf of Mexico”, James Cameron's Ad Hoc Deep Ocean Group, Jun. 1, 2010. http://www.whoi.edu/fileserver.do?id=64963&pt=10&p=44453
[Hammer] “Discovery of second pipe in Deepwater Horizon riser stirs debate among experts”, David Hammer, The Times-Picayune, Jul. 9, 2010. http://www.nola.com/news/gulf-oil-spill/index.ssf/2010/07/post_{—}19. html
[Mowbray] “BP removes containment cap in preparation for method that could contain more oil”, Rebecca Mowbray, The Times-Picayune, Jul. 10, 2010. http://www.nola.com/news/gulf-oil-spill/index.ssf/2010/07/bp_removes_containment_cap_in.html
[OSC Working Paper 6] “Stopping the Spill—The Five-Month Effort to Kill the Macondo Well”, National Commission on the BP Deepwater Horizon Oil Spill and Offshore Drilling, Staff Working Paper No. 6., Jan. 11, 2011. http://www.oilspillcommission.gov/sites/default/files/documents/Updated%20Containment%20Working%20Paper.pdf
[OSC Recommendations] “Deep Water—The Gulf Oil Disaster and the Future of Offshore Drilling—Recommendations”, National Commission on the BP Deepwater Horizon Oil Spill and Offshore Drilling, January 2011. http://www.oilspillcommission.gov/sites/default/files/documents/OSC_Deep_Water_Summary_Recommendations_FINAL.pdf
[Wells] “BP Kent Wells Technical Briefing Transcript”, BP, Jul. 10, 2010. http://www.bp.com/liveassets/bp_internet/globalbp/globalbp_ukenglish/gom_response/STAGING/local_assets/downloads_pdfs/kent_wells_presentation_transcript_{—}07_{—}10_{—}201

### BACKGROUND

### Discussion of the Prior Art

In the summer of 2010, a catastrophic and deadly explosion occurred at the Deepwater Horizon oil well in the Gulf of Mexico. After failed attempts to place containment devices over the well's broken riser pipe, that pipe was cut just above the BOP (blow-out preventer), and an oil containment cap called the “top hat” was installed in early June, hooking onto the top flange of the BOP. The top hat was not tightly sealed, however. As a result, oil continued to flow into the Gulf for weeks afterwards. Only when a tightly-sealed cap was placed over the BOP on July 15 was the oil flow finally stopped.

These events called the world's attention to the fact that, in an accident of this kind, a tightly-sealed attachment site for an oil-containment device is a matter of critical importance.

Before the capping of the Deepwater Horizon, there really wasn't much established prior art in stopping oil spills 5000 feet deep in the ocean. Consider the following quotes from the January 2011 report of the National Oil Spill Commission:
The most obvious, immediately consequential, and plainly frustrating shortcoming of the oil spill response set in motion by the events of Apr. 20, 2010 was the simple inability—of BP, of the federal government, or of any other potential intervener—to contain the flow of oil from the damaged Macondo well. [1]
Clearly, improving the technologies and methods available to cap or control a failed well in the extreme conditions thousands of feet below the sea is critical to restoring the public's confidence that deepwater oil and gas production can continue, and even expand into new areas, in a manner that does not pose unacceptable risks of another disaster. [2]
Beyond attempting to close the blowout preventer stack, no proven options for rapid source control in deepwater existed when the blowout occurred. BP's Initial Exploration Plan for the area that included the Macondo prospect identified only one response option by name: a relief well, which would take months to drill. Although BP was able to develop new source-control technologies in a compressed timeframe, the containment effort would have benefited from prior preparation and contingency planning. [3]

What this means is that much of the prior art in this matter, if there is any, is to be found in the rapidly improvised solutions which BP, together with experts from the U.S. Coast Guard, the Department of Energy, the National Labs, and other groups, were able to fashion over the course of the emergency. The exact details of what they did and how they did it have not, at this writing, been made fully public. However, it is possible to piece together a partial account of how they arrived at the sealing method for the successful cap.

Anyone who knows even a little about industrial plumbing realizes that a standard plumbing flange, with its flat surface, and its standardized mounting holes, can be used to create a tight seal. From the earliest days of the spill, confusion and frustration emerged from the fact that everyone could see, in the live video feed of the leaking well, a two-part pipe flange fixture at the top of the BOP. People wanted to know, why can't you just take off the top half of that flange, and attach a tight-fitting device onto the remaining bottom half?

This seemed like a sensible suggestion, and it is also, in essence, what was eventually done with success. In fact, investigators have reported that this option was discussed internally by BP within a week of the blowout. [4]

But early on, there is strong evidence to suggest that BP and other experts were not sure if the top half of the flange could be removed at all, or if it could be done safely. This kind of thing had never been attempted in deep water, and BP had no established procedure for doing it. [5] [6]

Moreover, there may have been concerns about whether removing the top flange would damage the BOP, and make things a lot worse. Experts had realized that the BOP may have already been damaged during the accident, in both known and unknown ways. [7] It was not known how delicate it might be. In an effort to understand what had occurred within the BOP, and what was its current inner state, gamma ray scans were undertaken, at the suggestion of Secretary of Energy Steven Chu, in mid-May. [8]

There are reports that, during this period, suggestions by BP and other contributors for how to seal the leak were carefully scrutinized by scientists from three DOE national laboratories. [9][10] Particular attention was given to interventions that might be too intrusive on the BOP, or on the surrounding rock, running the risk of making things worse. [11][12]

Complicating matters, it was revealed around July 9 that there were not just one but two drill pipes trapped inside the BOP. This discovery had been a surprise to BP, and further raised public worry that the true state inside the BOP was not fully understood. [13] There may have been concerns that the trapped drill pipes, being in contact with both the top flange and the partially shut-off area within the BOP, might make it dangerous to shift the position of the top flange.

The removal of the top flange was finally carried out after diligent preparation and scrutiny. It was a very complex procedure. [14] Hydraulic jacks were used to straighten the flex joint just under the top flange, which had been bent 3 degrees during the original accident. [15] BP wasn't sure they would actually be able to unscrew the flange. As a back-up plan, they had built a flange-splitting tool capable of using hydraulic rams to force the two halves of the flange apart. [16]

Careful planning and practice had been required to try to assure that the operations were safe, and that they could be performed by the ROVs (Remotly Operated Vehicles) which were available.

What this makes clear, in our view, is that blow-out preventers really ought to be equipped in advance with some kind of fixture or device which could be used to attach a tight-sealing cap in a manner which would be fast, ROV-friendly, and non-intrusive with respect to the interior state of the BOP. If possible, this attachment should be designed so that it can be carried out without the need for the complex, potentially risky process required to take apart the top flange of the damaged BOP.

If a tight-sealing cap could have been installed early enough, most of the oil that entered the Gulf could have been captured, preventing billions of dollars in damages to the economy and environment of the Gulf Coast.

### Notes

[1] OSC Recommendations, page 31.
[2] Loc. cit.
[3] Ibid., p 32.
[4] OSC Working Paper 6, p 26.
[5] Ibid., p 1.
[6] OSC Recommendations, p 32.
[7] Cameron, pp 11-12.
[8] OSC Working Paper 6, pp 8, 15.
[9] Ibid., pp 13-14, 24, 27.
[10] OSC Recommendations, p 32.
[11] OSC Working Paper 6, pp 17, 24, 27.
[12] Cameron, p 7.
[13] Hammer, p 1.
[14] OSC Working Paper 6, p 28.
[15] Mowbray, p 2.
[16] Wells, p 4.

### SUMMARY

In accordance with the present invention, there is provided an emergency redundant mounting flange which can be incorporated into the construction of a blow-out-preventer (BOP), enabling the rapid, tight-fitting attachment of an oil containment cap over an outlet port of the BOP in the event of an emergency. This emergency mounting flange extends concentrically outward from the protected port, and includes an annular region provided with a connection feature, such as a ring of regularly-spaced holes.

There is further provided a containment adaptor device or “cap”. This is a barrel-shaped diameter-reduction pipe which can be connected onto the emergency mounting flange at its bottom end, and onto a standard riser pipe, or other intermediate device, at its top end, thus restoring the oil well to a state where oil is no longer being released into the ocean. The containment adaptor device fully encloses the protected port, while creating a tight seal with the emergency mounting flange.

While the sealing of oil leaks is the most significant application for these ideas, it is also shown how the devices described can be adapted to other kinds of plumbing environments, such as reinforced concrete bell-and-spigot plumbing.

### Advantages

It is an object of the invention to enable a leak from a compromised BOP to be quickly capped, so that oil flow is either blocked entirely, or extracted without significant release.

Another object of the invention is to reduce the risk of further damage to the BOP by permitting the capping of a BOP without the need to make intrusive emergency BOP modifications, such as removal of parts.

An additional object of the invention is to provide a capping process which is ROV-friendly, in the sense that it can be easily performed by underwater Remotely Operated Vehicles.

A further object of the invention is to provide a matching, pre-built containment adaptor, so as to reduce the amount of special equipment that must be built to cap a leaking well, and the time required to build such equipment.

Finally, it is also an object of the invention to encourage the creation of standards for capping devices and procedures, so as to make it easier for emergency response teams to practice capping procedures in advance, with the goals of reducing risk and response time during an emergency, and also of facilitating interoperability between different emergency response organizations.

### BRIEF DESCRIPTION OF THE DRAWINGS

17 drawing sheets, presenting 19 figures, are included in this application.

FIG. 1 is a perspective view of a prior art plumbing flange component.

FIG. 2 is a perspective view of an assembled prior art plumbing joint, incorporating a top flange and a bottom flange.

FIG. 3 is a front view of the assembled prior art plumbing flange shown in FIG. 2.

FIG. 4 is a perspective view of one embodiment of an extended flange, in accordance with the present invention.

FIG. 5 is a perspective view of an assembled plumbing joint in accordance with the present invention, incorporating an extended bottom flange and a prior-art top flange.

FIG. 6 is a front view of the assembled plumbing joint shown in FIG. 5.

FIG. 7 is a perspective view of an alternate embodiment of the present invention, this embodiment being an extended adaptor plate which can be retrofitted onto an existing BOP without replacing the lower half of the top joint.

FIG. 8 is a perspective view, from a narrow angle, of an assembled plumbing joint incorporating prior art top and bottom flanges, with the extended adaptor plate of FIG. 7 sandwiched between them.

FIG. 9 is a front view of the 3-layer adaptor plate joint shown in FIG. 8.

FIG. 10 is a perspective view of an assembled plumbing joint incorporating an extended bottom flange and a prior-art top flange, with a damaged riser pipe remnant attached, this pipe remnant leaking oil into the ocean.

FIG. 11 is a perspective view of the transition adaptor, an oil-containment cap in accordance with the present invention, installed on top of the damaged plumbing assembly shown in FIG. 10.

FIG. 12 is a side view of the transition adaptor shown in FIG. 11, with a cutaway revealing a cross-section through a bisecting plane of the adaptor, this cross-section showing details of how the several components of the combined installation are connected.

FIG. 12A is a detailed side view of the nuts and bolts shown to the left of the cutaway in FIG. 12, identifying each of those fasteners in terms of its position as presented in FIG. 11.

FIG. 13 is a perspective view of the top flange joint of a BOP, similar to the joint seen in FIG. 5 and FIG. 8, showing the joint encased in a protective structure so as to shield the extended flange from damage.

FIG. 14 is a cross-section view of a prior-art joint between two reinforced concrete pipes, using the bell-and-spigot joining technology.

FIG. 14A is a cross-section view of a concrete pipe joint incorporating an extended ring pipe, a device designed to allow for the installation of containment caps in the event of a leak.

FIG. 15A is a cross-section view of an emergency installation using the extended ring pipe, in which a bell-connected containment cap encloses a leaking, damaged pipe remnant.

FIG. 15B, similar to FIG. 15A, is a cross-section view of an emergency installation using the extended ring pipe, in which a spigot-connected containment cap encloses a leaking, damaged pipe remnant.

FIG. 16B is a cross-section view of a 3-part concrete pipe joint incorporating two standard pipes, sandwiched around the extended adaptor ring, a device which, in a joint of this kind, provides similar emergency connection capacity to the joint shown in FIG. 14A.

### REFERENCE NUMBERS FOR DRAWINGS

The following tabulation is a list of numbered parts appearing in the figures. The number or part code is shown in the first column, followed by a description of the item. The Figures column is a list of the figures in which that item is marked. In cases where there are too many figures to fit in the column, the list of figures is shown on the next line of the table.

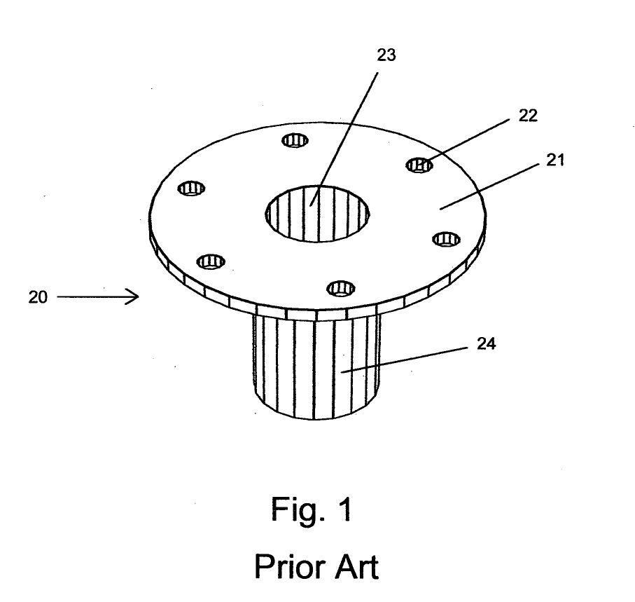

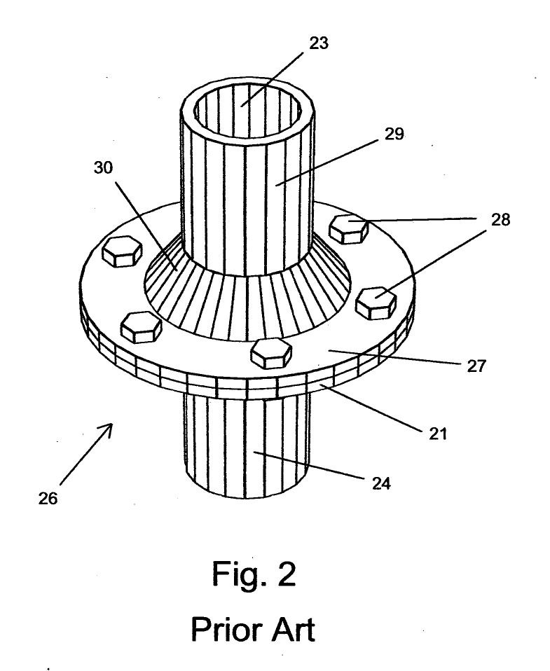

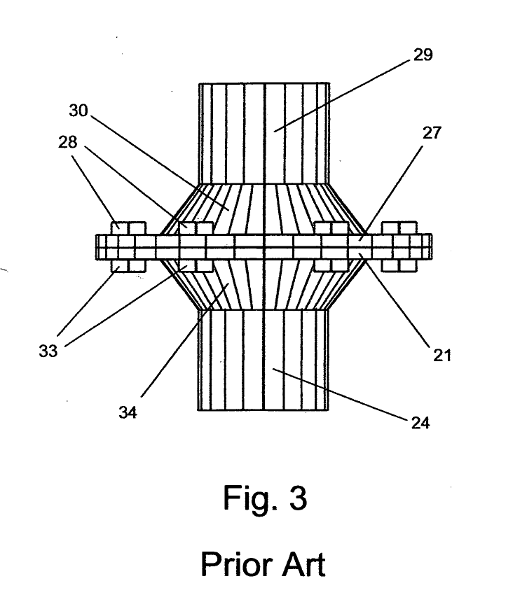

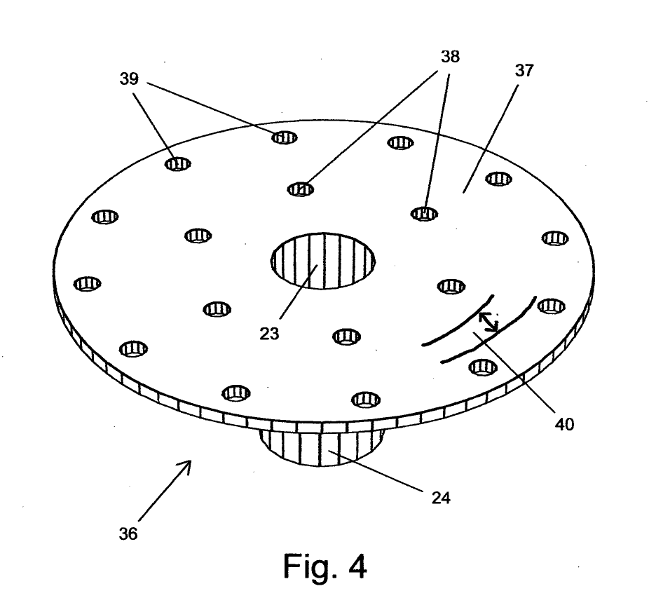

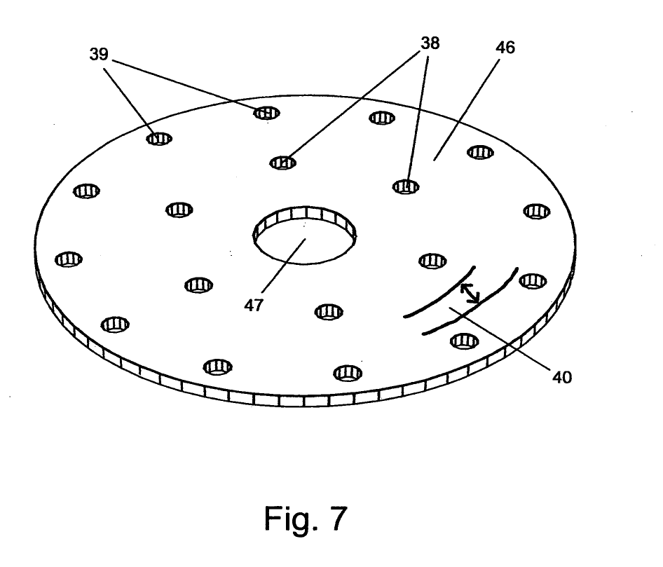

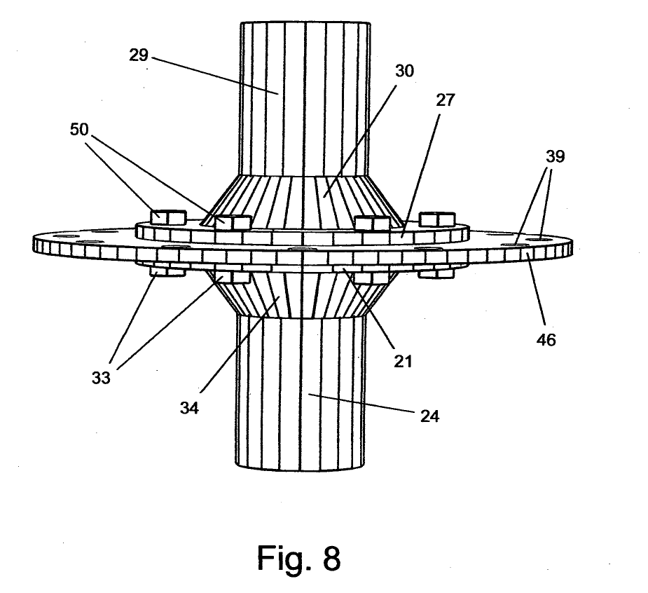

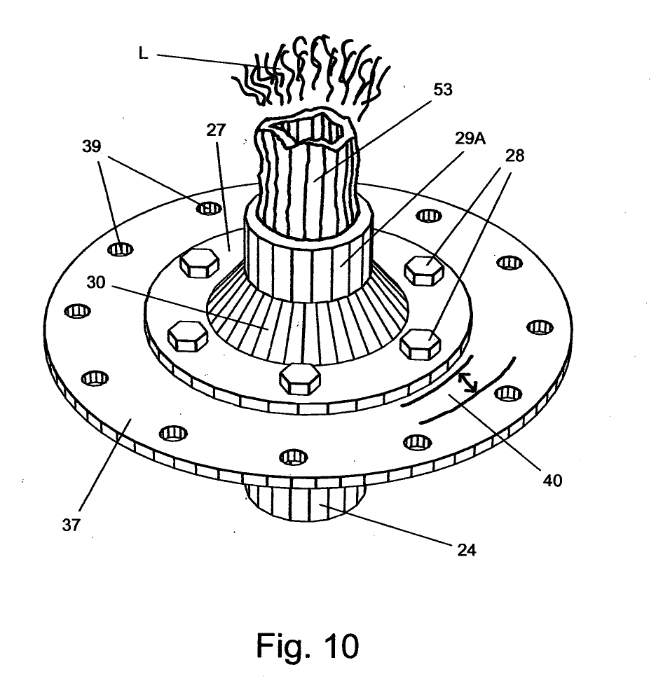

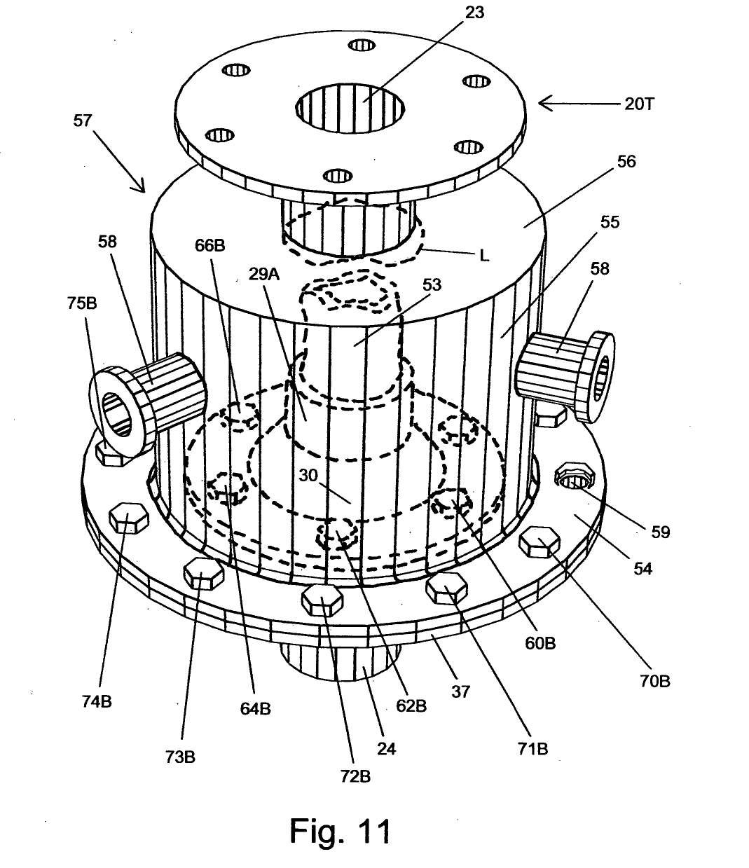

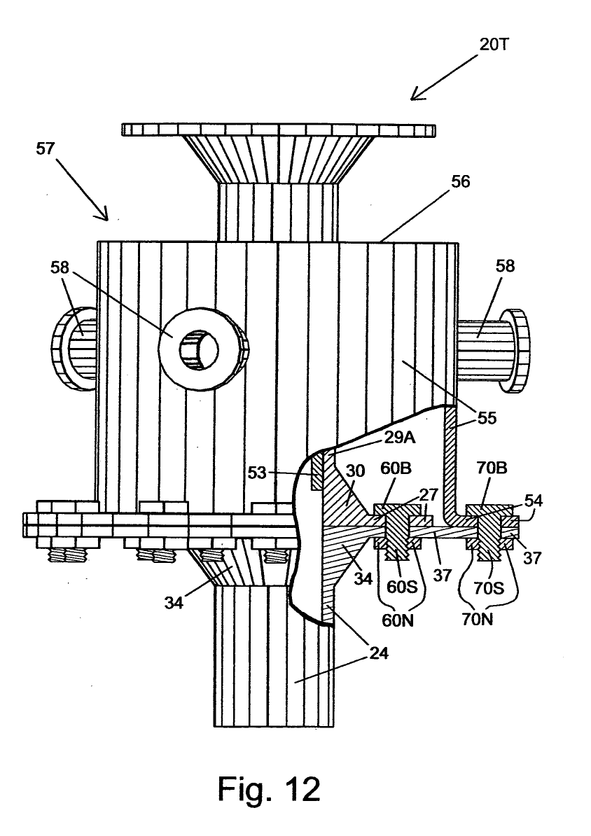

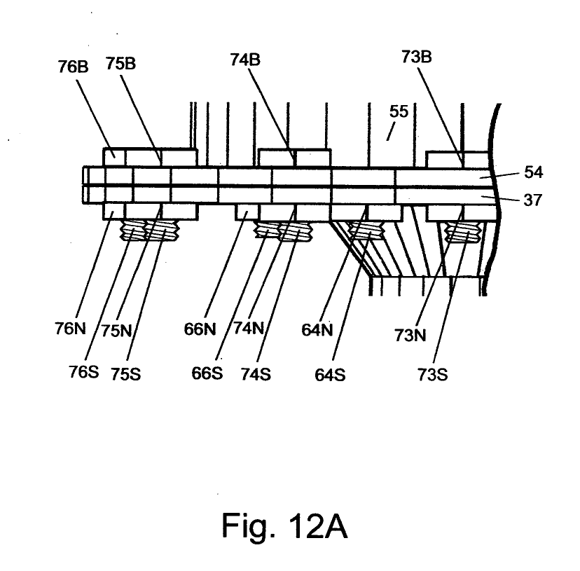

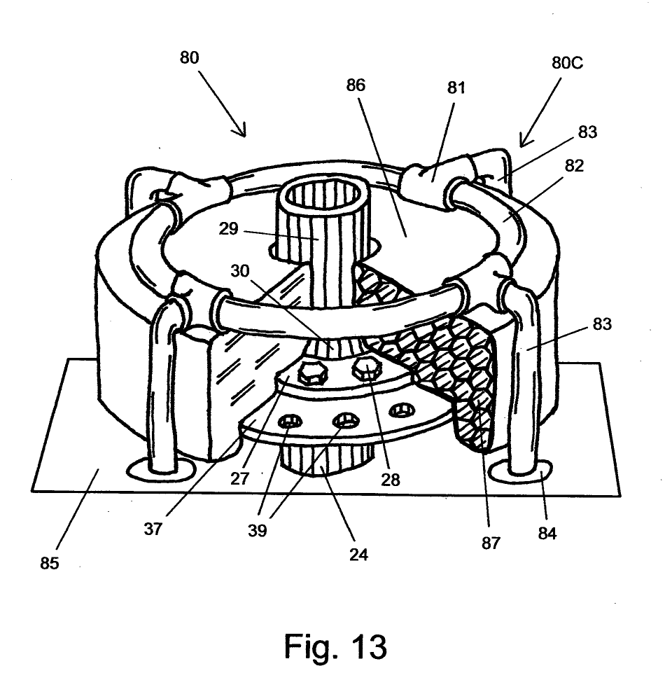

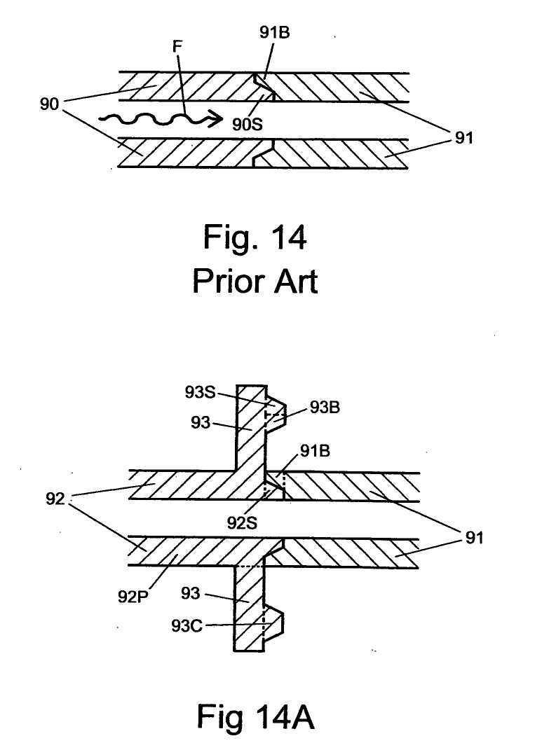

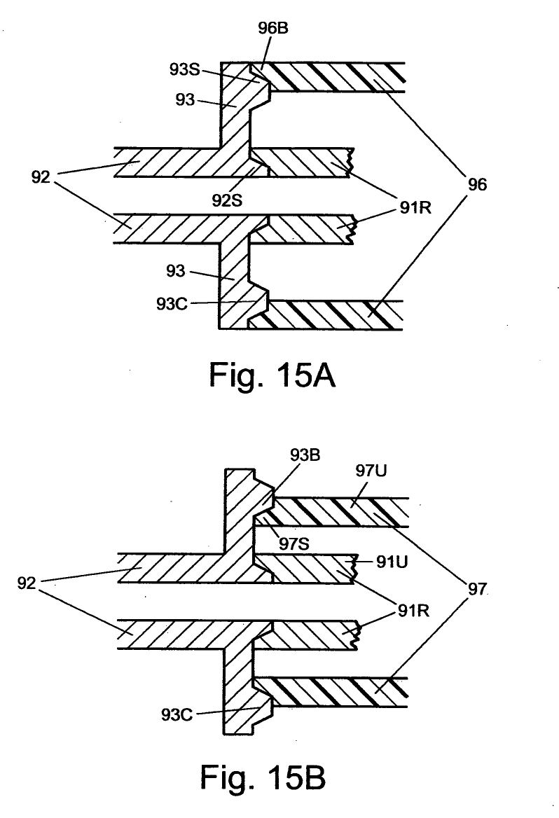

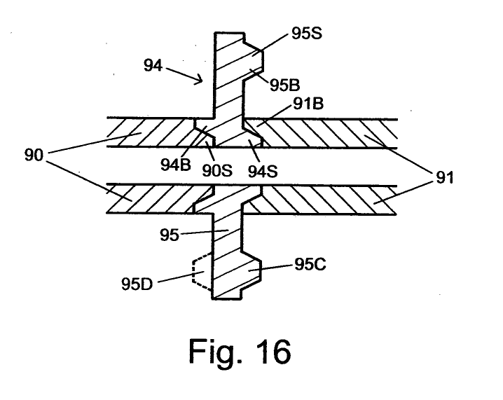

Parts which are groups or aggregates are indicated in the table with the symbol “&”. Some of the parts have alternate names, or abbreviated names, which are shown here in parentheses.

| ## | Description | FIGS. |
|---|---|---|
| 20 | prior art plumbing flange & | FIG. 1 |
| 20T | top flange component | FIGS. 11 12 |
| 21 | lower plate (horizontal plate) | FIGS. 1 2 3 8 9 |
| 22 | bolt holes | FIG. 1 |
| 23 | flow opening | FIGS. 1 2 4 5 11 |
| 24 | lower shaft (shaft) | FIGS. 1 2 3 4 5 6 8 9 10 |
| | | 11 12 13 |
| 26 | prior art assembled flange joint & | FIG. 2 |
| 27 | upper plate (flange plate) | FIGS. 2 3 5 6 8 9 |
| | | 10 12 13 |
| 28 | bolts | FIGS. 2 3 5 6 10 13 |
| 29 | upper shaft | FIGS. 2 3 5 6 8 9 13 |
| 29A | short upper shaft | FIGS. 10 11 12 |
| 30 | upper support collar (support collar) | FIGS. 2 3 5 6 8 9 10 |
| | | 11 12 13 |
| 33 | nuts | FIGS. 3 6 8 9 |
| 34 | lower support collar | FIGS. 3 6 8 9 12 |
| 36 | extended flange & | FIGS. 4 5 6 |
| 37 | extended lower plate (extended plate) | FIGS. 4 5 6 10 11 |
| | | 12 12A 13 |
| 38 | inner bolt holes | FIGS. 4 7 |
| 39 | outer bolt holes | FIGS. 4 5 7 8 10 13 |
| 40 | adaptor space | FIGS. 4 5 7 10 |
| 46 | extended adaptor plate | FIGS. 7 8 9 |
| 47 | plate 46 flow opening | FIG. 7 |
| 50 | longer bolts | FIGS. 8 9 |
| 53 | cut-off riser pipe (riser pipe) | FIGS. 10 11 12 |
| 54 | cap mounting flange (mounting flange) | FIGS. 11 12 12A |
| 55 | barrel | FIGS. 11 12 12A |
| 56 | top plate | FIGS. 11 12 |
| 57 | transition adaptor (cap) & | FIGS. 11 12 |
| 58 | accessory ports | FIGS. 11 12 |
| 59 | cap bolt holes | FIG. 11 |
| 60B | inner bolt at 12:00[*] | FIGS. 11 12 |
| 60N | matching nut for 60B | FIG. 12 |
| 60S | shaft of 60B | FIG. 12 |
| 62B | inner bolt at 2:00 | FIG. 11 |
| 64B | inner bolt at 4:00 | FIG. 11 |
| 64N | nut for 64B | FIG. 12A |
| 64S | shaft of 64B | FIG. 12A |
| 66B | inner bolt at 6:00 | FIG. 11 |
| 66N | nut for 66B | FIG. 12A |
| 66S | shaft of 66B | FIG. 12A |
| 70B | outer bolt at 12:00 | FIGS. 11 12 |
| 70N | matching nut for 70B | FIG. 12 |
| 70S | shaft of 70B | FIG. 12 |
| 71B | outer bolt at 1:00 | FIG. 11 |
| 72B | outer bolt at 2:00 | FIG. 11 |
| 73B | outer bolt at 3:00 | FIGS. 11 12A |
| 73N | nut for 73B | FIG. 12A |
| 73S | shaft of 73B | FIG. 12A |
| 74B | outer bolt at 4:00 | FIGS. 11 12A |
| 74N | nut for 74B | FIG. 12A |
| 74S | shaft of 74B | FIG. 12A |
| 75B | outer bolt at 5:00 | FIGS. 11 12A |
| 75N | nut for 75B | FIG. 12A |
| 75S | shaft of 75B | FIG. 12A |
| 76B | outer 6:00 bolt | FIG. 12A |
| 76N | nut for 76B | FIG. 12A |
| 76S | shaft of 76B | FIG. 12A |
| 80 | extended flange protection unit & | FIG. 13 |
| 80C | protective cage & | FIG. 13 |
| 81 | cage joints | FIG. 13 |
| 82 | roll bars | FIG. 13 |
| 83 | support posts | FIG. 13 |
| 84 | post fasteners | FIG. 13 |
| 85 | top of BOP | FIG. 13 |
| 86 | flange cushion ring | FIG. 13 |
| 87 | honeycomb material | FIG. 13 |
| 90 | concrete inflow pipe | FIGS. 14 16 |
| 90S | pipe 90 spigot ring | FIGS. 14 16 |
| 91 | concrete outflow pipe | FIGS. 14 14A 16 |
| 91B | pipe 91 bell ring | FIGS. 14 14A 16 |
| 91R | damaged remnant outflow pipe | FIGS. 15A 15B |
| 91U | remnant pipe upper section | FIG. 15B |
| 92 | extended ring pipe | FIGS. 14A 15A 15B |
| 92P | pipe 92 pipe-like portion | FIG. 14A |
| 92S | pipe 92 inner spigot ring | FIGS. 14A 15A |
| 93 | pipe 92 extension annulus | FIGS. 14A 15A |
| 93B | pipe 92 outer bell ring | FIGS. 14A 15B |
| 93C | pipe 92 extension connector | FIGS. 14A 15A 15B |
| 93S | pipe 92 outer spigot ring | FIGS. 14A 15A |
| 94 | extended adaptor ring & | FIG. 16 |
| 94B | adaptor 94 inner bell ring | FIG. 16 |
| 94S | adaptor 94 inner spigot ring | FIG. 16 |
| 95 | adaptor 94 extension annulus | FIG. 16 |
| 95C | adaptor 94 extension connector | FIG. 16 |
| 95D | alternate site for extension connector | FIG. 16 |
| 96 | bell containment cap | FIG. 15A |
| 96B | cap 96 bell ring | FIG. 15A |
| 97 | spigot containment cap | FIG. 15B |
| 97S | cap 97 spigot ring | FIG. 15B |
| 97U | cap 97 upper section | FIG. 15B |
| F | direction of fluid flow | FIG. 14 |
| L | leaking material | FIGS. 10 11 |

[*] Note: The “clock numbers” 12:00, 2:00, etc., in the bolt descriptions refer to relative angular positions of the bolts: 12:00 for 12-o'clock, 2:00 for 2-o'clock, etc. These designations will be explained in greater detail in the descriptions of FIGS. 11, 12, and 12A.

### DETAILED DESCRIPTION—Structure

In order to properly understand the present invention, it is helpful to compare it to a standard industrial plumbing flange of the prior art, shown in FIGS. 1, 2, and 3.

### Prior Art Flanges

FIG. 1 shows a prior art plumbing flange 20. It has a horizontal plate 21 used to create a seal with a matching plate on a matching flange. The plate has a plurality of bolt holes 22 through which bolts will be placed to fasten the top and bottom flanges, and to apply sealing pressure. A flow opening 23 allows for passage of fluid through the flange, while a shaft 24 provides a means of attachment onto a pipe, normally by welding or screwing the pipe into place. (The flange of FIG. 1 also has a support collar which is hidden, in this view, by the plate. The support collar will be visible in FIG. 3.) The shaft 24 will also be referred to as a “lower shaft” when the flange 20 of which it is a part is the lower of two flanges in an assembled flange joint. Similarly, the horizontal plate 21 will be referred to as a “lower plate” under those same conditions.

FIG. 2 shows a prior art assembled flange joint 26. Two matching flanges like the one in FIG. 1 have been bolted together so that their plates form a seal. The upper plate 27 and lower plate 21 are held together by bolts 28. As in FIG. 1, we see the flow opening 23 in the upper shaft 29. The support collar 30 of the upper flange serves to strengthen the mechanical connection between the upper shaft and the plate. The support collar 30 will also be referred to as an “upper support collar” when the flange containing it is the upper of two flanges in an assembled joint. The lower shaft 24 is also visible in this figure, as it is in FIG. 1.

FIG. 3 is a front view of the prior art assembled flange joint shown in FIG. 2. In addition to the parts shown in FIG. 2, FIG. 3 also shows the nuts 33 attached to each bolt, as well as the lower support collar 34.

An Extra Flange when You Need It

One embodiment of our enhancement of the prior art flange, according to the present invention, is shown in FIGS. 4, 5, and 6. These figures will present analogous views to those seen in FIGS. 1, 2, and 3.

In FIG. 4, we see a perspective view of device called an extended flange 36. Similar in many respects to the prior art flange of FIG. 1, the extended flange has an extended plate 37 with an extra ring of material beyond that found in the prior art flange. In addition to the inner bolt holes 38, which match the bolt holes of the prior art flange, the extended flange also has a ring of outer bolt holes 39, separated from the inner bolt holes by an annular region of material called the adaptor space 40. These two features create a back-up, redundant connection capacity which will allow an assembled joint to be sealed, without being disassembled, in the event of an emergency. We will describe below how this is done.

The extended flange 36 also has a flow opening 23 and a lower shaft 24, much like the prior art flange of FIG. 1. The extended flange also has as a support collar that is not visible in FIG. 4.

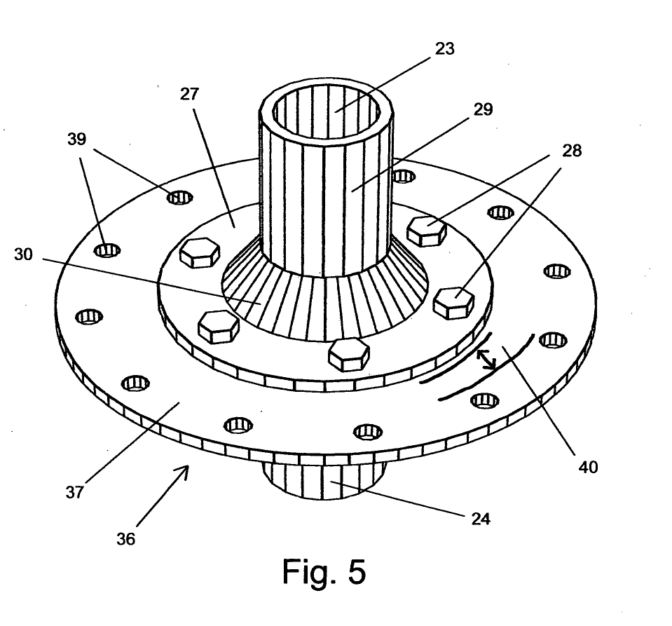

In FIG. 5, we see a fully assembled extended flange joint in perspective view. It is assembled by attaching a prior art flange 20 onto the top of the extended flange 36 of FIG. 4. This attachment is accomplished with bolts 28 in the same manner as in the prior art assembled joint of FIG. 2. The bolts connect the upper plate 27, on the prior art flange, to the lower plate 37, on the extended flange. As in FIG. 2, we can also see the flow opening 23 in the upper shaft 29, the support collar 30 of the upper flange, and the lower shaft 24 of the extended flange seen in FIG. 4.

The redundant ring of outer bolt holes 39 and the adaptor space 40 remain open and unobstructed, to be used in case of emergency as described below in the operation section.

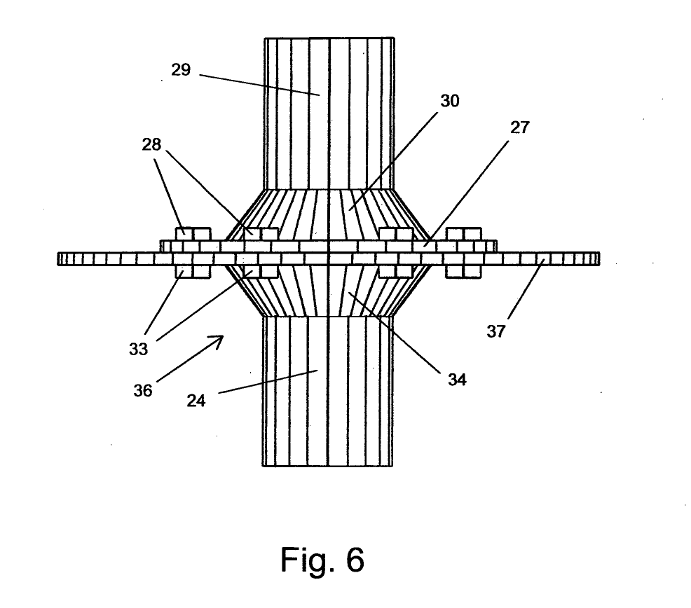

FIG. 6 is a front view of the assembled extended flange joint shown in FIG. 5. As in FIG. 3, we can now also see the nuts 33, and the lower support collar 34. Comparing FIG. 6 to FIG. 3, however, we see that the plate 37 of the lower flange extends out further than the plate 21 of the prior art flange. This larger plate 37 exposes the redundant features which provide emergency connection capacity, these features being the ring of outer bolt holes 39 and the adaptor space 40 seen in FIG. 5. Like FIG. 3, FIG. 6 also shows the upper shaft 29, the lower shaft 24, the upper support collar 30, the upper plate 27, and the bolts 28. The extended flange 36 first seen in FIG. 4 is also indicated here.

### A Simplified Form of the Extended Flange Device

FIG. 7 shows another, simpler embodiment of the present invention. Here we see an extended adaptor plate 46 similar to the extended plate 37 of the extended flange 36 visible in FIGS. 4, 5, and 6. Like the extended plate 37, the extended adaptor plate 46 has inner bolt holes 38, outer bolt holes 39, an adaptor space 40, and a flow opening, referred to as the adaptor plate flow opening 47. However, it does not have a shaft or a collar, because, when in use, it is meant to be sandwiched between two prior art flanges 20. These two flanges provide the means to connect to the pipes being joined, so the extended adaptor plate 46 does not need its own means to connect directly to a pipe.

FIG. 8 is a perspective view of an assembled extended adaptor plate flange joint. This view, from only about 3 degrees above horizontal, is very nearly a side view. This small viewing angle is chosen here so that features from both the top and the bottom of the device will be visible.

This joint is formed by sandwiching the extended adaptor plate 46 between two prior art flanges. Between the upper plate 27 of the upper prior art flange, and the lower plate 21 of the lower prior art flange, we see the extended adaptor plate 46. Extra long bolts 50 pass downward through the holes of the inner ring in all three plates, and are fastened below with nuts 33. The bolts need to be longer now that they are passing through three plates rather than just two as in the assembled joints shown previously. At this narrow viewing angle, we can barely see the ring of outer holes 39 of the extended adaptor plate.

The joint of FIG. 8 also shows many of the same parts seen in the assembled prior art flange joint of FIG. 3, these being the upper shaft 29, the lower shaft 24, the upper support collar 30, and the lower support collar 34.

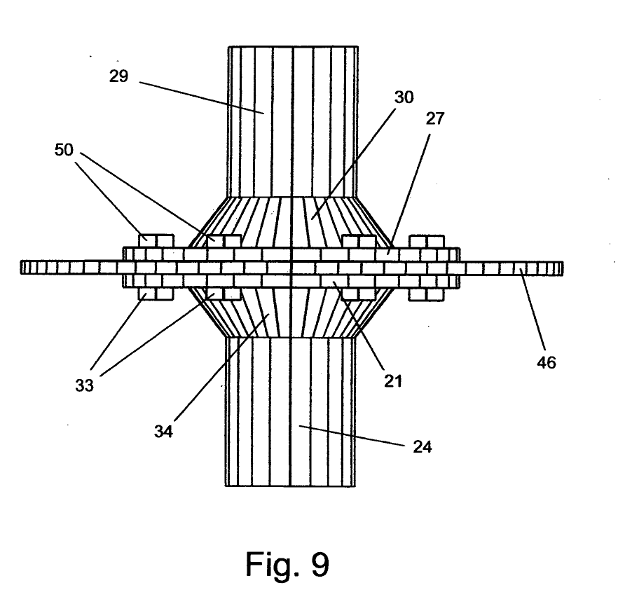

In FIG. 9, we see a side view of the assembled extended adaptor plate flange joint we have just seen in FIG. 8. We can again see the two prior art flanges, with an extended adaptor plate sandwiched between them. The numbered features in this figure are the same as those seen in FIG. 8, with the exception of the outer holes 39, which aren't visible from the direct side view we see here.

Comparing FIG. 9 to FIG. 3, we see that the two assemblies look much the same, except that, in FIG. 9, the upper and lower flange parts are further apart to allow space for the extended adaptor plate 46.

This simplified form of the extended flange is particularly suitable for retrofitting to existing installed BOPs. Extended flange capacity can be added without the need to replace the bottom flange of the top joint of the BOP. Instead, one simply removes the top flange, puts the extended adaptor plate 46 into position, and then replaces the top flange, using the extra-long bolts 50 to reattach it.

### A Containment Challenge

FIG. 10 is a perspective view of an assembled extended flange joint similar to that of FIG. 5. Here, however, the top flange has a short upper shaft 29A, to which a riser pipe 53 has been attached. The exact means of attachment is not significant here, but the riser pipe would probably have been welded or screwed into place. We see in the figure that the riser pipe 53 has been damaged. It has been broken and/or possibly cut off near the top of the upper shaft 29A. This is a situation similar to the state of the top flange joint on the Deepwater Horizon BOP between June 2 and Jul. 15, 2010. The breach in the riser pipe allows leaking oil L to flow out the top of the joint into the ocean.

The other numbered features of FIG. 10 are identical to those of FIG. 5.

We should explain why the upper shaft 29A shown in this figure is shorter than the upper shaft 29 we have seen before. This is not for any reason of structure or function relating to the present invention. Rather, it has to do with making particular parts visible in the figures. Both upper and lower shafts in previous drawings were made longer so that the lower shaft would be visible in perspective views. We could continue to show the longer shaft in FIG. 10, but, combined with the riser 53, it would take up too much vertical space in later figures. So, we made it shorter here.

### An Oil Containment Cap—the Transition Adaptor

We will now show how an oil containment device can be attached to the extended flange. FIG. 11 shows a transition adaptor 57 attached to the assembled extended flange joint seen in FIG. 10. The transition adaptor is a pre-manufactured oil containment device which is to be used in the event of an emergency. It can be bolted onto the ring of outer holes 39 of the extended flange so as to create a tight seal. The transition adaptor can also be referred to as an oil containment cap.

The transition adaptor 57 has a barrel-shaped cylindrical body 55, attached to a mounting flange 54. This flange is attached with bolts to the ring of outer holes 39 on the extended plate 37 of the extended flange. On the right, one of these bolts is shown in a cut-away view, revealing one of the bolt holes 59 in the mounting flange 54 of the transition adaptor. The upper part of the adaptor has a top plate 56, into which is mounted a top flange component 20T similar to the prior art flange 20 shown in FIG. 1. The transition adaptor 57 is also equipped with a plurality of accessory ports 58 mounted on the side of the barrel 55. These ports, not shown in great detail here, have a number of uses, which we will discuss later on.

The only openings through which fluid can flow in or out of the transition adaptor are (1) the bottom opening of the transition adaptor, bounded circumferentially by the mounting flange 54, (2) the accessory ports 58, and (3) the flow opening 23 of the top flange 20T.

The top flange port, and its flow opening, may also be referred to as the “extraction port” or “main extraction port” of the transition adaptor.

Inside the transition adaptor, shown in dotted lines, we can see the prior art top flange fixture shown in FIG. 10, including the short upper shaft 29A and the support collar 30. Attached to the short upper shaft is the damaged remnant 53 of the riser pipe. We can also see a schematic representation of the cloud of leaking oil L.

Finally, at the bottom of the assembled fixture, the lower shaft 24 of the extended flange assembly shown in FIG. 10 is visible here as well.

### Some Specific Bolts

Notice that in FIG. 11 there are 10 bolts, 4 on the inner ring and 6 on the outer ring, which have been given individual part labels. These bolts will be referred to in later figures, so it is useful to identify them here in detail. It should be noted that the exact position and spacing of these bolts is not a critical part of how the present invention works. Many suitable patterns of bolts or other fastening means would be adequate.

However, since these bolts will appear in later figures in a manner which may require some interpretation in order to be properly understood, we have given them some extra attention in this figure, as well as in the two following figures, FIGS. 12 and 12A.

The table below describes certain bolts visible in one of the following figures: FIG. 11, FIG. 12, and FIG. 12A. The table has four column headings: Bolt, Ring, Angle, and Figures. The Bolt column contains the label (part designation code) of the bolt. The Ring column says whether the bolt is in the inner ring or the outer ring. The Angle column shows the angle from the bolt 70B to the bolt described, with these angles being measured in degrees clockwise (looking down) around the cylindrical symmetry axis of transition adaptor barrel 55. The Figures column lists those figures in which that particular bolt, and/or its corresponding nut, are fully or partly visible.

TABLE 1
Bolt Identification Table

| Bolt | Ring | Angle | FIGS. |
|---|---|---|---|
| 60B | inner | 0° | 11 12 |
| 70B | outer | 0° | 11 12 |
| 71B | outer | 30° | 11 |
| 62B | inner | 60° | 11 |
| 72B | outer | 60° | 11 |
| 73B | outer | 90° | 11 12 12A |
| 64B | inner | 120° | 11 12 12A |
| 74B | outer | 120° | 11 12 12A |
| 75B | outer | 150° | 11 12 12A |
| 66B | inner | 180° | 11 12 12A |
| 76B | outer | 180° | 12 12A |

So, for example, bolts 62B and 72B are at the 2-o'clock position (60°) clockwise from bolt 70B, on the inner and outer rings, respectively.

Notice that labels for the inner ring bolts are in the 60's, while labels for the outer ring bolts are in the 70's. It may also be helpful to note that the second digit of the part code (label) is in each case a “clock face number” for the bolt. The angle will simply be 30 times this number. So, for example, bolt 75B, in the outer ring, is at the 5-o'clock position (5×30°=150°) relative to bolt 70B. The bolts in the inner ring are spaced 60° apart, so there is no 5-o'clock bolt to be found in the inner ring.

With this preparation completed, we will now move on to a further examination of the transition adaptor 57.

### Attachment of the Transition Adaptor

In FIG. 12, we see a side view of the assembly shown in FIG. 11. The transition adaptor 57 is placed over and bolted onto the outer ring of holes of the assembled extended flange joint shown in FIG. 10. Exposed by a cut-away, the figure shows a cross-section that illustrates in detail how the various layers of the assembly are connected. The plane of this cross section is the unique plane determined by two specific parallel lines, these lines being the (1) cylindrical symmetry axis of the adaptor barrel 55, and (2) the cylindrical symmetry axis of the bolt 70B, seen at the far right of the figure.

As in FIG. 11, we can see the adaptor barrel 55, the top flange component 20T and the accessory ports 58. The top plate 56 of the transition adaptor is seen edge-on in this view, so it is not visible. However, its surface plane is indicated in the figure. In the cross-section, we see the lower shaft 24, the lower support collar 34, and the extended lower plate 37. These three parts are all integral to the same piece of material. This material would normally be steel in many preferred embodiments. For example, steel is the standard material used for plumbing fixtures in the oil industry.

Notice that the continuity of the lower plate 37 in the cross-section is interrupted by the bolts as they pass through the bolt holes in that plate. Above there, we see the upper plate 27 of a prior art flange, the upper support collar 30, and just a bit of the short upper shaft 29A first seen in FIG. 10, all three of these parts being integral to the same piece of material. The upper plate 27, like the lower plate, is also interrupted in this view by a bolt-hole and the occupying bolt.

Attached to the upper support collar 30 and the short upper shaft 29A, we can see a piece of the riser pipe 53. In this cross-section, we can see how the upper plate 27 is fastened to the extended lower plate 37. Bolt 60B, first seen in the previous figure, is shown passing through holes in the two plates. It is fastened with nut 60N. The shaft of this bolt is given the designation 60S.

To the right of bolt 60B, we can see the details of how the transition adaptor 57 has been attached to the outer ring of holes on the extended lower plate 37. The vertical wall of the adaptor barrel 55 makes a right-angle turn, becoming the horizontal mounting flange 54. This flange is bolted onto the lower plate 37 by the bolts in the outer ring. The geometry of this attachment, as can be seen in the figure, is much the same as that seen in the inner ring, illustrated by bolt 60B. In the outer ring, bolt 70B, which we have seen in the previous figure, passes through one of the holes 59 (shown in FIG. 11) in the transition adaptor mounting flange 54, and then through an aligned hole below it, this hole being in the outer ring of holes (item 39 in FIG. 10) of the extended lower plate 37. The shaft 70S of this bolt is secured by nut 70N.

The adaptor space 40 (marked in previous FIGS. 4, 5, 7, and 10) can be seen here as the gap between the outer edge of the upper flange 27 and the shaft 70S of bolt 70B. We can now see the purpose and significance of this gap. This gap allows space for the adaptor flange 54 to clear the head of bolt 70B and then turn upward to become the adaptor barrel 55. Without the gap, the adaptor barrel 55 would collide with the edge of the upper flange 27, preventing the adaptor from seating properly onto the extended flange 37.

We should point out that, for purposes of visual clarity, the bolt holes, bolts heads, bolt shafts, and nuts have all been made somewhat wider and more detailed in this figure than they are in previous figures. This is also the case in the next figure, FIG. 12A.

We noted before that there would be a need for some precise bolt-tracking in the coming figures. Take a look at the bolts, bolt-shafts, and nuts shown at the center, and left-of-center, in FIG. 12. Some of the visible bolts are from the inner ring, some are from the outer ring, and some bolt-heads, nuts, and shafts, are partially obscured by others. It's a complicated view, when seen directly from the side.

In order to clarify what is pictured there, we have included another figure which identifies all these side-viewed fasteners in greater detail, and correlates them with the perspective view of FIG. 11, in which the parts in question are easier to identify and distinguish.

### Details of Bolt Positions

FIG. 12A is an enlarged view of the collection of bolts and nuts which can be seen to the left of the cross-section of FIG. 12. What we are looking at here is four bolts from the outer ring, and two from the inner ring. The inner ring bolts correspond to 64B and 66B in Table 1, the Bolt Identification Table, presented in our discussion of FIG. 11. However, the bolt heads for these two bolts are not visible here, being hidden by the wall of the transition adaptor barrel 55. What we can see, however, is all or part of the nuts and bolt shafts for these two bolts. For example, the 4-o'clock inner ring bolt shaft 64S, along with its matching nut 64N, is fully visible. The 6-o'clock inner ring bolt shaft 66S, and its matching nut 66N, are partially hidden behind the outer ring 4-o'clock bolt shaft and nut, designated as 74S and 74N respectively.

Since this bolt is in the outer ring, the bolt head 74B is visible on the top surface of the transition adaptor mounting flange 54. In addition to this one, we can also see three more outer ring bolt heads, these being 73B, 75B, and 76B. This is actually the first time we have seen 76B, since it was hidden behind the transition adaptor in FIG. 11. Bolt 73B, because it is the 3-o'clock (90°) outer bolt, is centered right on the midline of the flange fixture and the cap. Below it, the matching nut 73N and bolt-shaft 73S can be seen.

To make it easier to identify the nuts and bolt-shafts for the outer ring bolts, notice that the outer ring bolt shafts have been made just slightly longer here, by a single thread-cycle. Finally, note that the nut 76N and the bolt shaft 76S, seen on the far left, are partially hidden by nut 75N and shaft 75S.

Comparing the current figure to FIG. 11, and referring to the Bolt Identification Table, it should now be clear what the roles and positions are of the visible fasteners, and the partially visible fasteners, shown in FIGS. 12 and 12A.

### Protection for the Flange

Back-up systems designed to be used in an emergency are often the last line of defense in an industrial crisis. For them to be effective, they must be ready when they are needed, preferably undamaged by any accident which might necessitate their use.

In order to increase the odds that our extended back-up flange will remain undamaged and usable when needed, we propose to encapsulate it inside a removable protective barrier. FIG. 13 illustrates some simple ideas for how to accomplish that objective. Here we see the extended flange protection unit 80, surrounding an extended flange joint like the one shown in FIG. 5.

As a first line of defense, the protection unit has a simple protective cage 80C. This cage looks and functions kind of like a roll-bar in a racing car or an all-terrain vehicle. Preferentially made of thick steel, it is composed of cage joints 81 which connect a plurality of tubing members. These members are the roll-bars 82 and the support posts 83. These posts are attached to the top 85 of the BOP (or other device to be protected by the extended flange) by post fasteners 84. The fasteners are not shown here in any great detail, but it will be clear to practitioners how they should be constructed in particular applications.

The next line of defense is the flange cushion ring 86. This is an annular object made from an energy-absorbing material of some kind, similar to the “crumple zones”, and other protective devices, used to shield the passenger compartments of cars and trucks. The cushion ring could even include self-activating systems similar to automobile air-bags. We haven't illustrated such a device here, but the control electronics for it could be integrated into similar existing modules that are already used to control BOP safety systems. These BOP control modules, normally installed in redundant pairs, allow BOP features to be monitored and controlled from the ocean's surface. It would not be hard to add a similar interface for flange-protecting air bags to these modules.

In analogy with crumple zones, the cushion ring can be made of a material that will absorb energy when it is crushed. One option for this would be a honeycomb structure 87 made from steel, aluminum, or other suitable materials. This option is shown in a cut-away view on the right side of the figure. The cut-away is bounded by two planes containing the cylindrical axis of symmetry of the protected fixtures, these planes making a dihedral angle of about 75° with each other.

The section of the cushion ring that is removed by the cut-away reveals several features familiar from the earlier FIG. 5. These are the lower shaft 24 and, of course, the extended lower plate 37, which is the payload of our protective gear. We also see the outer bolt holes 39. The flange protection unit could also include plugs of some kind (not shown in the figure) designed to protect the holes 39 from impact damage, and also possibly from corrosion as well. Other extended flange assembly features visible here are the bolts 28, the upper plate 27, the upper support collar 30, and the upper shaft 29.

### Application to Bell-and-Spigot Plumbing

The devices we have presented so far have an extended ring of material which provides a redundant, back-up connection capacity for a bolted-flange plumbing joint. This concept can also be applied to other kinds of plumbing joint styles. In the following figures, we will illustrate how this can be done for plumbing technologies which use a bell-and-spigot joining method, as is common with reinforced concrete pipe.

In our discussion of bell-and-spigot plumbing, concrete pipe is the main practical area of application, and the focus of our examples. However, these ideas would apply to any form of plumbing that uses the bell-and-spigot joining method.

### A Prior-Art Bell-and-Spigot Joint

FIG. 14 shows a prior art bell-and-spigot joint between two pipes, shown in a cross-section through a vertical plane containing the axis of symmetry of the pipes. The inflow pipe 90 carries fluid from left to right, in the direction indicated by the wavy arrow F. The fluid flows through the joint and into the outflow pipe 91.

The inflow pipe has a spigot ring 90S, which joins with the bell ring 91B of the outflow pipe. At the interface between the spigot ring and the bell ring of the adjoining pipe, there may normally be various structures, such as gaskets, or (in the case of concrete pipe) steel support rings. However, these details of joint construction are not shown in our figures. Also, steel reinforcing rods, which would be visible in an actual physical cross-section of a reinforced concrete pipe, are not shown in the figures.

Bell-and-spigot connection structures are shown here, and in the drawings that follow, in a simplified schematic form. The geometry of actual bell-and-spigot fittings may differ substantially from the shapes seen in these figures.

### A Bell-and-Spigot Redundant Connector

In FIG. 14A shows a bell-and-spigot device analogous to the extended flange device 36 seen in FIG. 4. All the objects seen in this figure (and in the following three drawings, FIGS. 15A, 15B and 16) are rotationally symmetric about the central horizontal axis of the figure, and the objects are shown in cross-section through a vertical plane containing that axis.

The extended ring pipe 92 has much the same role in bell-and-spigot plumbing that the extended flange adaptor has in bolted-flange plumbing. Connected to the extended ring pipe 92 is a normal outflow pipe 91 like the one seen in FIG. 14. The extended ring pipe 92 connects to the pipe 91 with a bell-and-spigot joint, using the inner spigot fixture 92S of the extended ring pipe. The fixture 92S mates with the bell ring portion 91B of the outflow pipe 91. This connection works just like a normal bell-and-spigot connection between prior-art pipes, as shown in FIG. 14.

However, in the event of an emergency, the extended ring pipe, like the extended flange adaptor, has an extra “unit” of connection capacity which can be used to cap leaks. Notice the annulus of concrete 93 which extends outward from the pipe-like portion 92P of the extended ring pipe. This part of the structure, called the extension annulus, supports a ring of material 93C (labeled at the bottom of the figure) called the extension connector, or simply the connector. The connector 93C has two beveled portions 93B and 93S which can function as bell and spigot connection rings, respectively.

For clarity, the boundaries of certain portions of the extended ring pipe 92 and the outflow pipe 91 have been shown with dotted lines in this figure. The portions of the extended ring pipe 92 shown in this way are the pipe-like portion 92P, inner spigot fixture 92S, extension annulus 93, extension connector 93C, outer spigot fixture 93S, and outer bell fixture 93B. The portion of the outflow pipe 91 shown in this way is the bell ring 91B.

It is worth mentioning that the extended ring pipe 92 actually has a part called the “inner bell fixture”, or the “inner bell ring”. This part, which is not shown in the figure, is the bell ring at the opposite end (to the left) of the pipe-like portion 92P of the extended ring pipe.

### A Bell-and-Spigot Containment Cap

FIG. 15A shows an emergency response installation using the extended ring pipe. Imagine that the outflow pipe 91 in the previous figure has been damaged, and then cut off, leaving a remnant 91R still attached. We would like to put a cap of some kind over this remnant, and over the original joint between the outflow pipe and the extended ring pipe, so as to contain the fluid leak.

The outer portion 93S of the connector 93C is in fact a spigot ring which can be used to connect the extended ring pipe 92 to a pipe-like device 96, called the bell containment cap. Only the left-most portion of the bell containment cap 96 is visible here. It is a pipe-like object with a somewhat larger radius than the remnant 91R. The bell containment cap has a bell-type connection ring 96B at its left end which, as seen in the figure, is sealed to the spigot-type connection ring 93S of the extended ring pipe 92.

To the right of the area shown, the cap would have various features that might be needed for containment purposes, such as a bell-and-spigot outflow port connector matching the diameter of the outflow pipe 91. This outflow port would be in analogy with the top flange component 20T of the transition adaptor 57 introduced in FIG. 11. It will be clear how the other features of the bell containment cap could be configured, so we haven't shown those details in this figure.

### Another Kind of Bell-and-Spigot Containment Cap

Unlike bolted-flange plumbing, bell-and-spigot plumbing has a gender distinction in its connectors. The extended ring pipe 92 is designed so that it can be capped with a suitable device of either gender. FIG. 15B shows an emergency response installation similar to that of FIG. 15A. Here, however, the cap in use has a spigot connection that joins with a bell connection provided on the inner side of the extension connector 93C of the extended ring pipe 92. This cap is called the spigot containment cap 97. It has a spigot ring 97S which joins with the outer bell fixture 93B of the extended ring pipe 92.

To the right of the region seen in the figure, the spigot cap would have other features similar to those mentioned for the bell cap of FIG. 15A. Those features are not shown here.

(It may be noticed, in this figure, that the upper portion 97U of the spigot cap 97 cross-section, together with the upper portion 91U of the pipe remnant cross-section, may appear, in combination, to be similar to a spigot-ended pipe, such as the inflow pipe 90 seen in FIG. 14. However, this appearance is only an artifact of the cross-section view. Objects 91U and 97U are actually concentric rings of material, and separate objects, not two sides of the same pipe.)

### A Bell-and-Spigot Redundant Connector Add-On Device

In the bell-and-spigot environment, one can create an add-on device analogous to the extended adaptor plate 46 introduced in FIG. 7. In FIG. 16, we see a device called the extended adaptor ring 94. By sandwiching it between an inflow pipe 90 and an outflow pipe 91, a three-part structure is formed which has the same shape as the two part device shown in FIG. 14A, composed of an outflow pipe 91 attached to the inner spigot ring of the extended ring pipe 92.

The extended adaptor ring 94 has an inner bell ring 94B by which it joins with the spigot ring 90S of the inflow pipe, and an inner spigot ring 94S by which it joins with the bell ring 91B of the outflow pipe.

The extended adaptor ring 94, like the extended ring pipe 92, has an extension annulus 95. Part of this annulus is an extension connector 95C just like the extension connector 93C which is part of the extension annulus of the extended ring pipe.

Thus, both the bell cap of FIG. 15A and the spigot cap of FIG. 15B could be fitted onto the extended adaptor ring in an emergency.

In analogy with the extended adaptor plate and the extended flange, we can see that the extended adaptor ring, when assembled into a 3-part fixture as shown in FIG. 16, provides all the same emergency response functionality as the 2-part fixture shown in FIG. 14A.

### Providing Redundant Connection on the Bell Side

Because the bell-and-spigot convention has a gender polarity, there could actually be two different kinds of extended ring adaptors. The one shown in FIG. 16 provides redundant attachment capability on its spigot side, because that is where the extension connector 95C is found, with its outer bell ring 95B, and its outer spigot ring 95S. So the ring adaptor shown is “spigot-redundant”. A bell-redundant ring adaptor would have the extension connector on the opposite side, in the area 95D, indicated by a dotted line.

Alternatively, one could also build a ring adaptor with extension connectors on both sides (in both locations 95C and 95D), and it would therefore support the emergency connection of caps on both its bell side and its spigot side.

This concludes the detailed structural description section. We now go on to consider the function and operation of the present invention in greater depth.

### DETAILED DESCRIPTION—Function and Operation

The present invention can be thought of as an extended plumbing flange or redundant plumbing flange device. Unlike a normal plumbing flange, it can attach not just to one matching device, but also, in the event of an emergency, to a second, larger device, which, once installed, provides a secondary layer of fluid containment.

In order to clarify this, it is useful to first examine the standard type of plumbing flange used in the prior art. FIG. 1 shows the bottom half of a standard prior art flange 20. In FIG. 2, also in perspective, we see an assembled prior art flange with a bottom plate 21 and a top plate 27. FIG. 3 shows a front view of the assembled fixture.

Notice that the standard flange has only a single ring of holes 22. What this means is that once the matching upper half is attached, the “connection capacity” of the bottom flange is, in effect, all used up. It has no further connection sites or regions that can be used to seal a cap or similar extraction device onto it in the event of an emergency. In order to contain a leak from a damaged prior-art assembled flange, the flange would need to be disassembled, a step which, as we have discussed previously, may be risky or impossible in an emergency.

In FIG. 4, however, we see one embodiment of our redundant flange, which we also call an extended flange 36.

Like a normal flange, it has a flat plate 37 mounted to a cylindrical shaft 24. However, unlike a normal flange, our device has two rings of holes, not just one. The second, outer ring of holes 39 will remain accessible for use after a matching normal flange 20 is attached to the inner ring of holes 38.

In order to understand how this would actually work, let us examine FIG. 5. It shows a perspective view of an assembled extended flange installation; with a standard flange now bolted onto the top of our redundant flange. With pipes or other flow equipment (such as a BOP or manifold) attached to the two shafts 29 and 24, the plumbing joint seen here would carry fluid in precisely the same way as the a prior art plumbing joint of FIG. 2.

However, there is a crucial difference. Notice that our redundant flange still has an exposed ring of outer holes 39. It has what might be thought of as one extra “unit” of reserve pipe-connection capacity, embodied in this exposed outer ring holes. A containment device which has a flange matching this ring of outer holes could be attached there without needing to unbolt and take apart the joint. As we saw in our prior art discussion, this is a capability that was lacking in the Deepwater Horizon (DH) blowout, with catastrophic results.

What would such an emergency device look like, and what would we have to do in order to attach it? Imagine a barrel-shaped object with a flange at the bottom, a flange which would match the outer holes 39. If there was nothing in the way, we could simply slide it over the top of the joint shown in FIG. 5, and bolt it to the extended flange, achieving precisely the kind of tight seal that was so elusive in the many weeks of the DH spill.

### The Transition Adaptor Oil Containment Device

A device of this kind, called a transition adaptor 57, is shown in FIG. 11. Inside the barrel 55, shown in dotted lines, can be seen a prior art top flange, with upper shaft 29A, and support collar 30. Attached to it is a small piece of damaged riser pipe 53. A clearer picture of these inner details can be seen in FIG. 10, unobstructed by the barrel of the transition adaptor.

In FIG. 10, we can see the riser stub, attached to the top half of a flange joint, and leaking oil. This combination of factors is quite similar to the situation that existed at the top of the DH BOP for 6 weeks, beginning on Jun. 2, 2010. During that time, emergency response teams were not able to create a tight seal on the top of the BOP. It is estimated that, as a result, over 50,000 barrels of oil per day were released into the Gulf waters. This would not have happened if there had been an extended flange device mounted on the BOP, a device like the one shown in FIG. 10.

Of course, it would obviously be necessary to remove all but a small portion of the riser pipe first, before attaching the cap 57 to the extended flange. This was done on June 2 in in the Deepwater Horizon response, in preparation for the installation of the “top hat” cap. But the top hat did not have an easily-sealed surface to mate with, and oil continued to flow into the ocean during the entire time it was in place.

The cap shown in FIG. 11 is called a transition adaptor because it creates a transitional fluid flow path from one plumbing context to another. A more conventional kind of transition adaptor might be a diameter-reduction device. In order to connect a 4-inch pipe to a 2-inch pipe with a tight seal, you need an object with some form of 4-inch connector at one end, and a 2-inch connector at the other. In the context of an oil-well blowout, however, the two plumbing contexts we want to connect are (1) a compromised joint like the one shown in FIGS. 10, and (2) some form of standard, un-compromised plumbing connector.

Once we have this hypothetical second connector in place, we have a number of good options. We can attach it to a standard riser pipe, and bring oil to the surface in the conventional manner. We can attach it to other pipes which would connect to a storage or distribution manifold, from which oil could then be brought to extraction ships at the surface. Or, we can attach the un-compromised connector to a new, additional BOP, so that the extraction process has the indispensable protection that a BOP provides. (Similar options to these were considered, attempted, and/or carried out during the DH response.)

Thus, the essential transition which the cap must achieve is to connect a compromised joint to an un-compromised one, in a fluid-tight way. And indeed, this is exactly what our cap 57 does. Because of the presence of the pre-installed extended flange 37 on the later-compromised plumbing joint, our cap is able to connect to the compromised joint with its bottom flange 54. At the top of our cap is an undamaged, un-compromised standard flange 20T. It's really very simple, when you look at FIGS. 10 and 11 and think about how and why it works. But all of this is only possible because of the extended flange 54 which we have added to the top joint of the BOP.

### Accessory Ports

The cap 57 has accessory ports 58 mounted in the side of the barrel 55. Ports of this kind provide an alternate means for injecting or removing fluids from the cap. An important use of the accessory ports involves the control of methane hydrate crystals. Methane hydrate can form in the ocean under conditions of high pressure and low temperature, from a chemical reaction between methane gas and water. The failure of the containment dome, or cofferdam, which BP tried to install over the broken riser pipe of the DH well on May 7, was caused by methane hydrate clogging. (OSC Working Paper 6, p 11)

Blockage of this kind can be prevented by injecting warm water or methanol into a region where methane hydrates might form. The accessory ports 58 can be used for such injection during the installation of the cap. Once the cap has been bolted into place, however, hydrate formation becomes less of an issue, because there is no longer a supply of water entering the bottom of the barrel. Since oil is lighter than water, there may still be some water sitting in the annular region around the shaft 29A of the fixture inside the cap. However, if desired, this water can be removed in various ways, such as by extracting it using a narrow tube inserted through the top opening 23 of the cap, or through one of the accessory ports.

### Angular Position of Accessory Ports

It is worth noting that the accessory ports 58 (three of them in this example) are placed so that they are not directly over the transition-adaptor bolt-holes (these being the bolt-holes 59 of FIG. 11.) Instead, the centers of the accessory ports lie at a 15-degree midpoint between consecutive bolt holes of the outer ring. This placement is intended to take into account the fact that the installation of the bolts in the outer ring—to be performed by ROVs—will probably be easier if the accessory ports are not positioned directly above the bolts. There, they might obstruct the positioning of tools used to insert and tighten the bolts. This is a minor point, however, because it would not be hard to devise ROV-friendly tools and methods for installing the bolts even if the ports were located above bolt holes, provided there was adequate clearance to get the bolts into proper position for insertion.

### Important Installation Factors

In order for this containment response strategy to succeed, its two essential components, the extended flange and the transition adaptor, must be available and must work properly when needed. This proper function involves several notable issues or factors, which we will now consider in turn.

### Proper Fitting of the Cap

When installed, the transition adaptor must fit properly. In particular, there must be adequate clearance between the barrel 55 and the standard flange plate 27. FIG. 12 shows a cross-section detail which reveals exactly where this clearance must be provided. Between the two bolts 60B and 70B, just past the outer edge of the flange plate 27 of the smaller, inner fixture surrounded by the adaptor, there is a small gap. This gap, between the edge of the plate 27 and the curved area of the adaptor, where the barrel 55 and the mounting flange 54 meet, is essential if the cap is going to seat properly. The exact amount of clearance needed can be determined by standard practices used in industrial plumbing, including some testing and digital modeling if necessary.

When planning for this clearance however, it should be kept in mind that the cap is going to be installed by ROVs. The kind of delicate position adjustments that could be made directly by human eyes and hands won't be an option. For this reason, an extra inch or two of clearance, beyond what might be required for a human-installed object, may be a good idea here.

This gap, called the adaptor space 40, is marked in perspective views of the extended flange, seen in FIGS. 4, 5, and 10.

In reference to FIG. 12, we again note the somewhat confusing appearance of the nuts and bolts visible to the left of the cut-away area. These features are individually labeled in FIG. 12A, and described in detail in the Bolt Identification Table found in the Structural Description of Drawings, a previous section of this document.

Returning our attention to the adaptor space, it should also be kept in mind that steel (the preferential material for the cap and extended flange) contracts when it gets cold. Differences in types and even in batches of steel can lead to small variations in the amount of such contraction. It is therefore recommended that transition adaptors and extended flange plates should be manufactured together, and tested as well, if necessary, in the ocean, in order to make sure they actually fit under conditions similar to those that would occur in a real emergency. You don't want to end up in a situation where you can't get bolts into place because of an unexpected 2 mm offset in the alignment of the bolt holes in the flange plates.

We will have more to say about the installation and use of the cap in a later section.

### Proper Mechanical Support for the Cap

In order for any new fitting to be safely added to a BOP, it must first be determined if the BOP can handle the extra weight. For example, prior to installing the capping stack, which was successfully used to close the DH well on July 15, BP performed an analysis, with help from the National Labs, which concluded that the DH BOP was capable of supporting the weight of the capping stack. (OSC Working Paper 6, p 27)

Similar analyses would be needed before installing the transition adaptor described in the present invention. We believe that most BOP installations would be capable of safely supporting the extra weight of the transition adaptor cap.

### Mechanical Protection for the Extended Flange

Another essential function element is the shape and mechanical integrity of the extended (or redundant) flange. If the extended flange becomes damaged or distorted in an accident, it may not be possible to properly seal the cap against it. The typical threats faced by the extended flange in an accident would be mechanical ones. During the events of the Deepwater Horizon crisis, the top flange of the BOP was subjected to intense forces while the rig itself, with its position-control systems compromised as a result of the gas explosion and fire, drifted on the surface of the ocean, pulling on the BOP, and its top joint, via the then-intact riser pipe. An emergency disconnect system (EDS) designed to close the BOP, and then detach the riser pipe from it, in such “drift-off” emergencies, also failed. (Cameron, pp 11-12)

Later, when the rig actually sank, the riser pipe broke in a number of places, and fell to the sea floor in several pieces. As far as is known, no portion of the riser actually fell on the BOP, nor, fortunately, did the sinking rig itself. However, the possibility that riser pipes, or even parts of ships or oil rigs, might fall on top of a BOP is a real one.

FIG. 13 shows an installation we call the extended flange protection unit 80. It has a roll-bar-like protective cage 80C, and an energy-absorbing flange cushion ring 86. These components are designed to protect the extended flange surface 37 during an accident.

Once accident operation response begins, however, both the cage and the cushion ring must be removed in order to clear the space above the plumbing joint, so the cap 57 can be fastened in place. A specific, rapid, ROV-friendly means for effecting this removal must be designed and tested, but we haven't included any details in FIG. 13 of how that might be done. One option would be to cut the support posts 83 with a large shears of the same kind that was used to slice off the riser of the DH well. Another approach would be to equip the post fasteners 84 with a simple release mechanism. Once the cage is out of the way, it shouldn't be too hard to lift the cushion ring 86 off the top shaft 29. Even simpler, the cushion ring could be built in 2 or 3 mechanically separate and disconnected parts, which could simply be pulled away once the support posts are gone.

Another detail that should be considered in the design of the protection unit 80 concerns the flexibility property of the top joint of the BOP. The top joint is also called the “flex joint”. These joints are designed to allow a certain amount of angular movement of the riser pipe. This permits some limited movement of the oil rig at the ocean's surface to occur without snapping the pipe, or damaging the BOP. In order to accommodate this movement, the post fasteners 84 could be removed and replaced with curved portions of pipe that would clasp the underside of the cushion ring 84. The result would be that the protection unit would “float”, moving with the top joint of the BOP when necessary. Another approach would be to put some flexibility into the connection between the post fasteners 84 and the support posts 83. A heavy steel spring would probably be adequate. The details of this would also depend on the design specifics of particular BOPs, and would emerge naturally as part of any implementation effort.

### Storage of Caps

An oil-containment method in the manner of the present invention will not work if the cap is not there when you need it. Caps should be pre-manufactured, and stored in known locations. Making more than one cap for each installed extended flange will increase the odds that you can find one in an emergency. Multiple caps won't be a huge expense either. The caps we have described are quite inexpensive when compared to the cost of a BOP, which is a far more complicated piece of equipment. So making a few caps for each protected BOP installation will not add much, in percentage terms, to the overall cost of a BOP installation.

It might seem reasonable to keep a containment cap on the oil rig, but this should certainly not be the only place where one is stored. As happened in the DH blowout, the rig itself may be lost. Caps could be kept on emergency response ships that serve the area where the oil well is located, but there again, ships do sink from time to time. Perhaps the best compromise between speed and reliable access is to store the caps on land, in a location that is only a matter of hours, by transport helicopter, from the site of the oil well.

As a general rule when designing fault-tolerant systems, one should try to avoid situations where a back-up resource is also at risk from a known threat to the primary device. Thus, for example, a wired-in household smoke detector may rely directly on a building's power wiring, but its backup battery typically does not. This principle is relevant to the choice of storage sites for our containment caps. For each extended-flange-protected oil well, at least one matching cap should be stored in a location that is not in the path of hurricanes which may threaten the oil well itself. Imagine how disappointing it would be, in the event of a well blowout caused by hurricane-related events, to discover that the very same hurricane had also destroyed the warehouse where the only matching containment cap was stored.

If fixtures of kind we have described here come into common use, an industry standard for such fittings may also be formulated. The interchangeability provided by a parts standard is a convenience we are all familiar with, in product areas ranging from household plumbing, to batteries, to light bulbs. In oil spill containment, interchangeability could play a significant role in raising the odds of being able to locate a necessary part in an emergency.

### A Simplified Extended Flange Allows for Retrofitting

Based on the design illustrated in FIGS. 4, 5, and 6, newly-constructed BOPs could be created with redundant flanges, so as to provide the kind of back-up oil-containment protection we have described in the present invention.

However, there may also be a need to retro-fit existing BOPs, possibly including those already in operation on active oil wells. One option for retrofitting would be to remove both the top and bottom flange elements of the top joint of an existing BOP, and replace them with an extended flange joint like the one seen in FIG. 5. This kind of an operation, however, is quite intrusive to the BOP. Removing the top flange from the top joint of a BOP is feasible. (This was done in the DH response.) But for some BOPs in current use, it isn't clear if the bottom flange of the top joint can be removed at all while the BOP is in operation, especially if this has to be done by ROVs. This might make it difficult or impossible to retrofit these BOPs.

Fortunately, there is an extremely simple version of the extended flange which solves this problem. This alternate embodiment of the present invention is literally nothing more than a flat steel plate with some holes in it. (Nineteen holes, as it happens, in the example we will present.)

Take a look at FIG. 7. There we see just such a plate. This is the extended adaptor plate 46. It has the same pattern of holes found on the extended plate 37 of the extended flange 36, this being the device shown in FIGS. 4, 5, and 6. In order to get extended-flange functionality from the extended adaptor plate 46, the plate is simply added as an extra layer into an existing prior-art plumbing joint.

Starting with a plumbing joint of the kind shown in FIGS. 2 and 3, we disassemble the joint, put an extended adaptor plate on top of the lower flange, and then reinstall the upper flange on top of that. For a given standard family of flanges, the adaptor plate will have a matching pattern of inner holes, so that the holes of all three layers of the new joint are aligned. The new combination device can be fastened together with extra long bolts, these being ones which are long enough to get through all three layers with room to spare for a matching nut.

FIG. 8 shows just such a device. The viewing angle chosen in the figure is quite narrow so that we can see features on both sides of the newly added extended adaptor plate 46. Comparing FIG. 8 to the assembled extended flange joint shown in FIG. 5, it is clear that the fixture seen in FIG. 8, just like the one shown in FIG. 5, will allow for the installation of the cap, or transition adaptor 57, shown in FIGS. 11 and 12.

FIG. 9 shows a side view of the assembled extended adaptor plate joint shown in FIG. 8. The plates 21 and 27 of the prior art flanges are shown, with the extended adaptor plate 46 sandwiched between them. Comparing FIG. 9 to FIG. 6, which shows a side view of an assembled extended flange joint, it is again clear that a cap 57 may be fitted onto extended adaptor plate joint of FIG. 9 just as it may be fitted onto the extended flange joint of FIG. 6.

With that said, however, a number of issues should be noted in connection with the use of the extended adaptor plate in retrofitted installations, as follows.

### The Mechanical Strength of Extended Adaptor Plate Joints

If an extended adaptor plate is to be retrofitted onto an existing BOP, we need to know that this BOP, thus altered, will continue to have the mechanical properties it requires in order to operate safely. Noting the close similarity of FIGS. 9 and 6, we might come to the conclusion that this is not a change to be concerned about. However, it should not simply be assumed that the adaptor plate joint of FIG. 9 will have the same mechanical properties as the extended flange joint of FIG. 6 in all areas critical to BOP performance.

For example, consider lateral, or shear forces on the top joint. The top joint, or flex joint, of a BOP may at times be subject to powerful lateral forces if the rig above it moves off its preferred position. The flex joint is designed to accommodate such motion, but there may be significant differences in how a 3-layer joint, as compared to a 2-layer joint, responds to lateral force. Careful mechanical analysis, and/or computer simulation, should be undertaken to ensure in advance of installation that the 3-layer joint is really strong enough to handle the demands placed on the top joint of a BOP.

### Installation Issues for the Extended Adaptor Plate

The extended adaptor plate embodiment of the present invention is intended to make retrofits easier than they would be if both flanges of the top joint of a BOP had to be replaced. Even with an extended adaptor plate, however, retrofitting is a challenging, expensive, and potentially risky operation.

In order to take apart the top joint of the BOP, oil flow from the well must first be turned off. Many BOP models would allow such a shut-off to be achieved within the BOP itself using a valve of some kind, an annular closure device, or a non-destructive, reversible ram closure device. But some models might not have this capacity.

Moreover, even if a BOP does have an internal shut off, an abundance of caution might suggest that, to provide an extra layer of protection for the well during operations on the BOP, the well should actually be sealed up with concrete during the procedure. This would mean placing one or even two concrete plugs in the well's casing pipe. All of these operations add expense to the retro-fit. Nevertheless, such operations may be deemed necessary. As the DH blowout has reminded us, caution is essential in deep-water oil drilling. Standards for such caution might include existing safety policies, both those in use before the DH blowout, or newer ones put in place since then.

In order to apply such policies, it may be useful to identify more familiar oil-drilling procedures that would involve comparable operations, and comparable risks, to those which would be involved in an extended adaptor plate retrofit. For example, an adaptor plate retrofit is roughly comparable to a replacement of the riser pipe. In both operations, the well must be shut off somehow while the top flange is taken apart and then reassembled.

### Risk Management Factors

One of the bitter lessons of the DH blowout has been that if you are going to fully rely on a safety device as a last line of defense, you had better be sure that it is going to work. The BOP was viewed in the oil industry as the final safety net. But it turned out that there were conditions under which the BOP would fail. One condition was the presence of more than one tool-pipe at a time in the BOP. The shear rams of the BOP can cut through one tool-pipe, but not through two at once. Another condition was created by a human error sometime before the explosion, in which a crucial rubber sealing ring in the BOP was accidentally damaged, and not replaced before resuming drilling operations.

What these examples show is that it is always a good idea to have an accurate picture of what the weaknesses of any supposedly fail-safe device really are. Of course, no device is going to be 100% fail-safe, because one can never rule out surprises. Nevertheless, diligent analysis of safety vulnerabilities, and a reasonable attempt to compensate for them, should be part of any installation we depend upon in matters of public safety. An approach of this kind is clearly part of best practice in the oil industry.

The technology we present here fits very nicely into this kind of problem-solving. The design of the BOP is meant to achieve a rapid closure of a compromised well, in a matter of seconds or less. But if that attempt fails, and multiple attempts by other rams of the BOP also fail, at that point, the BOP will probably no longer have any capability to stop the leak. At that point, one is facing a situation where the opportunity to stop the leak in a matter of seconds or minutes is no longer present. What one is left with is potentially the opportunity to stop the leak within a matter of hours or days, rather than weeks, or even months if the drilling of relief wells turns out to be the only recourse.

This is exactly what our extended flange can do. It has no leak-stopping capacity on a time scale of seconds or minutes. But on a time scale of hours or days, once the BOP's options have been exhausted, it can make a huge difference.

To be concrete, consider that, in the DH response, 42 days elapsed between June 2, when the riser was cut off just above the BOP, and July 15, when the well was finally closed with a tight-sealing cap. We believe that, with proper logistics and preparedness, a transition adaptor could be installed on an extended flange in about 3 days or less.

Comparing this 3 day period with the 42 day period seen in the DH crisis, we find a reduction of over 92% in capping time, and hence also (approximately) in total oil released. Imagine how different things would have been in the DH response if total oil leakage had been only 8% of what it actually turned out to be. This is astounding when you think about it, because the present invention is really an extremely simple mechanical device. It is in no way a substitute for a BOP, but, in combination with a BOP, the extended flange provides a back-up capacity, offering containment options which can make a huge difference in an accident of the kind we saw in the Gulf Oil Spill of 2010.

Comparison with Double-Hulled Oil Tankers

The kind of protection achieved by the present invention can be thought of as somewhat analogous to that provided by the second hull of a double-hulled oil tanker. Here, however, the situation is different in two respects. First, the “backup” hull is the outer one, (the cap 57) not the inner one as with a double-hulled oil tanker. Second, in the present invention, the backup hull—this being the cap—is attached only in the event of an emergency. Only a small portion of that hull, namely the extended flange, is present in the initial installation. But that small portion is crucial, because it is equipped with a connection feature (the outer ring of holes 39) which allows the remainder of the backup hull (that is, the cap) to be fastened in place quickly, easily, and by ROV-friendly means.

### Redundant Connection Devices for Bell-and-Spigot Plumbing

The extended flange fixtures we have presented provide a capacity to attach a second layer of containment to a damaged plumbing joint. In FIGS. 14, 14A, 15A, 15B, and 16, we examine devices which provide this same kind of back-up protection for bell-and-spigot plumbing environments, such as reinforced-concrete plumbing.

FIG. 14 shows a prior-art bell-and spigot plumbing joint, connecting an inflow pipe 90 to an outflow pipe 91. In any kind of plumbing scheme, there can be problems which create leaks. If pipe 91 were to break, for example, the standard response might be to detach it from pipe 90, and then replace it. During this process, the fluid source might be turned off, if it was possible to do that.

However, in analogy with the broken riser pipe of the DH oil well, we will here consider an accident in which, for some reason, (1) the fluid flow cannot easily be turned off, and/or (2) there are good reasons not to attempt to take apart the inflow joint (as shown in FIG. 14), leading to the compromised pipe.

In a situation like that, the redundant connection concepts we have proposed for bolted-flange plumbing can be applied. Suppose that, instead of pipe 90, the originally installed inflow fixture to the later-compromised joint had been a fixture like the extended ring pipe 92 shown in FIG. 14A. In an emergency where a leak has occurred downstream from this joint (to the right in these figures) we could then take the following steps to contain the leak.

First the outflow pipe 91 attached to the spigot ring 92S of the extended ring pipe 92 would be broken off, or cut off, reducing it to a short length. The result would be like the pipe remnant 91R shown in FIG. 15A. This trimming operation would be done carefully so as not to disturb the joint with the extended ring pipe 92, which, by hypothesis, is for some reason better left intact.

Next, a matching, pre-manufactured cap would be attached to the connection feature 93C, of the extended ring pipe. The inflow end of the cap (the one that connects to the extend pipe ring) would look like larger-diameter pipe, shown in cross-section in FIG. 15A as part 96. It would completely enclose the pipe stub 91R. In fact, the outflow pipe would have been specifically cut off to a length short enough to fit inside the cap. The outflow end of the cap is not shown in the figure, but it might simply be a diameter-reduction adaptor with a spigot outflow connection. We could attach an extraction pipe or other containment plumbing to this outflow port.

As we have explained previously, the connection feature 93C of the extended ring pipe also allows for a bell-type cap to be used, as shown in FIG. 15B.

A bell-and-spigot device analogous to the extended adaptor plate is shown in FIG. 16. It allows for the construction of a 3-part joint with the same emergency connection capabilities as the 2-part joint of FIG. 14A. These 3-part and 2-part joints are analogous to those shown in in FIGS. 9 and 6, respectively, in the context of bolted-flange plumbing.

### Protection for the Bell-and-Spigot Redundant Connection Devices

In analogy with the extended flange protection unit 80 shown in FIG. 13, a protective system of some kind could be built for the bell-and-spigot emergency connection devices we have described. We won't examine in detail here how this might be done. Presumably it would depend on the specifics of the application. For example, some reinforced concrete pipes are underground, while others are not. For some installations, as in an oil-well BOP, the primary threats to a joint might arise from being pulled upon, or having things fall on the joint. For others, earthquakes or explosions might be the primary threats.

We only note here that, as with the extended flange protection unit, a back-up system is only going to help you recover from a disaster if the system itself has not been disabled by that disaster. The lesson then is a very general one—harden your backup systems, or they may not be there when you need them.

### Comparison to Deepwater Horizon Spill

In the category of bolted-flange plumbing, the Deepwater Horizon oil spill provides a specific illustration of the potential value of the methods we have described. And in fact, that emergency was the inspiration for the basic containment idea of the present invention.

We do not know of a comparable real-world example of an emergency involving bell-and-spigot plumbing where a containment strategy of the kind we propose here would have made a critical difference. However, the bell-and-spigot examples illustrate the generality of the basic containment idea of a back-up connector which surrounds the primary connector with a joining site for a larger flow-capturing device.

### CONCLUSION

One of the clearest determinations found in the final report of the National Oil Spill Commission is that new technology should be put into place to provide a range of effective options for preventing and stopping deep-water oil leaks.

In their final recommendations, the Commission quotes investigators of the loss of the space shuttle Columbia, who pointed out that “complex systems almost always fail in complex ways.” (See [OSC Recommendations], p viii.)

This might lead us to the belief that solutions which significantly reduce the odds of a sustained deep-water oil leak will of necessity also be complex. The present invention, however, provides an extremely simple technology. So simple, in fact, that one of its embodiments is nothing more than a flat piece of steel with some holes in it. Moreover, the solution proposed, while innovative, is based on steel plumbing technology, an industrial craft which is over a century old.

This simple solution addresses what, for all the complexity of its causation, is actually a fairly simple problem to describe. A BOP has failed, and the attached riser pipe has broken, causing oil to leak into the sea. What can we do? If there's an extended flange on the BOP, and it has remained undamaged, we can cut off what's left of the riser, and then bolt an available, pre-manufactured cap onto that flange, in a matter of a few days, without making intrusive modifications to the compromised BOP.

When you think about it, adding a simple solution to a complex system provides another advantage as well. Complex solutions require complex technology, and making complex technology fail-safe is not so easy to do, as the failure of the Deepwater Horizon safety systems has shown us. But when technology is simple, it may well be easier to see how it might fail, and then take steps to protect it. Can something go wrong with a flat plate of steel? Certainly. But understanding what might go wrong, and taking steps to prevent that, is a far easier problem to solve than making that same analysis for a more complicated device.

Whether our approaches are simple or complex, based on old or new technology, we need to do a better job of keeping oil where it belongs.

It is our hope that the present invention can become part of an arsenal of new and effective methods for preventing and containing deep-water oil leaks, and that we will never again see an oil spill as deadly, as damaging, or as costly, as the Gulf oil spill of 2010.

### A Memorial Note

The invention we have described here is only an oil containment device, not a means of preventing blowouts from occurring in the first place.

The correct operation of oil-well blow-out preventers is not just a matter of protecting our ecosystems and our economy. It is also a matter of life and death. Eleven men lost their lives on the Deepwater Horizon oil rig on Apr. 20, 2010. Mindful of the loss suffered by these men and their families, it is our hope that oil companies and the agencies which regulate them will in the future become increasingly vigilant and effective in all matters of safety, and take whatever steps may be required to protect the lives of the men and women who work in the oil industry.

### Scope of the Invention

### Context of Application

In the above discussion, we have focused on the application of the present invention to compromised BOP stacks. However, the present invention can be helpful in other kinds of situations as well. The distinctive application features which may serve to make the present invention beneficial and cost-effective in a particular circumstance are as follows:
(c1) The source of the leaking fluid cannot simply be turned off while repairs are undertaken.
(c2) Removal of an existing connection may be difficult, impossible, risky, or time-consuming
(c3) The damage caused by a leak, and the perceived probability of such a leak, would justify redundant measures allowing rapid, safe response to such leaks.

In addition to oil-well blow-out preventers, examples of situations where one or more of these factors could be present might include certain pipe-lines, water mains, drainage pipes, dams and spillways, hydroelectric plants, and plumbing associated with chemical plants or nuclear reactors. Emergencies of this kind could also occur in laboratories or manufacturing facilities where chemically, biologically, or radiologically hazardous substances are created, processed or stored. Such crises could also occur in manned or unmanned space-vehicles, where the scarcity of various fluids, and the risk associated with their loss, could be a critical factor.

It is our intent here to include this broader range of situations in the scope of application of the present invention, as detailed in the claims to be set forth below.

### Dimensions

The relative dimensions shown in the figures are only for purposes of illustration. Actual dimensions would be determined by engineering considerations relating to the specific context of application. No particular size is intended or implied. The size of the plumbing devices employed could range from the microscopic, up to the scale of the very largest plumbing in use, such as might be found in water mains or dams.

### Geometry

In the examples we have shown, the secondary or redundant connection region (the outer ring of holes, in our examples) is always in the same plane as the primary connection region (this being the inner ring of holes in our examples). However, this co-planarity is not necessary to the functioning of the device. For example, in the extended adaptor plate 46 of FIG. 7, the outer ring of holes could be higher up than the inner ring. With this modification, the plate would now look like a bowl, with the outer holes being located in a horizontal annulus of material around the rim of the bowl. Or, the outer ring of holes could be lower than the inner ring, leading to an inverted bowl shape.

The planes of the primary and secondary connection regions do not even have to be parallel. If, for some reason, it was considered advantageous to slant the secondary ring relative to the primary, the device could still be made to work properly, provided the flange of the cap was also slanted so as to fit on the secondary ring.

Each of our examples shows a device whose outer ring is round. This also is not really a necessity. For example, the outer “ring” of holes could actually be square, provided that the matching flange on the cap was square as well. With this in mind, we may, in the claims to be set forth below, sometimes refer to a “pattern of holes” rather than a “ring of holes”, when describing the inner and outer connection features of the bolted-flange versions of our fixtures.

Finally, our examples also have the feature that the outer ring is concentric with the inner ring. While most preferred embodiments would have this feature for various reasons, the function of the device does not depend on it. The secondary flange could be off-center in relation to the primary flange, provided that there was still enough clearance for a matching cap to be attached.

### Topological Requirements

The above geometrical generalizations can be summarized by making the observation that two of the primary functional requirements of the device are really topological, not geometric. In order for the device to work, two conditions must be met, as follows.
(t1) The annulus of material connecting the inner, primary connection ring to the outer, back-up connection ring must be continuous, and without gaps, so that its surface can become part of a closed surface (*) which encapsulates the leak.
(t2) The cap must make a fluid-tight seal with the back-up ring, along some closed boundary, free of gaps, so that the cap and the connecting annulus provided by the extended flange, when these two objects are joined, form a closed surface (*).
(*) Here, the term “closed surface” should be understood to refer to a surface that is fully closed to the movement of fluid except through the leak orifice itself, or through the main extraction port, or the accessory ports, of the cap.

Examination of these conditions will show that the requirements they describe are topological, rather than geometric. Thus, the particular geometric features of the examples we have given, while they may be beneficial and convenient for various reasons, are not essential to the basic function of the device described.

It is worth noting, however, that there is an operational requirement with more of a geometric content, that being the requirement that enough of the riser pipe must be removed so that the cap will fit over what remains of the riser pipe.

### Materials

Steel is currently the preferred material used in many areas of industrial plumbing. New materials are constantly being discovered and invented, however, and all of the devices and procedures described here could be adapted to different kinds of materials.

In addition to steel, another material we have considered for use in the redundant plumbing attachment devices of the present invention is concrete, typically reinforced concrete, connected with bell-and-spigot joints.

In a context where plumbing fixtures may be made out of concrete, one can imagine situations where it would be of great value to have a redundant device surrounding a plumbing joint in such a way as to provide rapid, back-up connection capacity.

### Means and Style of Fastening

In the examples we have presented, our redundant flange is attached to the transition adaptor with nuts and bolts. However, it is evident that the function and utility of the device is not dependent on the means of fastening, but only on the proper performance of that means, whatever that means may be. It is our intent to include in the scope of the present invention any means of fastening which provides fluid-tight sealing adequate to prevent substantial leakage, and which also provides mechanical stability adequate to keep the fixtures in place. For example, certain kinds of temporary steel-pipe plumbing attachments might use hydraulic clamps instead of nuts and bolts, or screw-clamp devices (similar to the C-clamps used in carpentry) to apply pressure on two surfaces from the outside so as to seal them and hold them in place.

Moreover, as we have indicated in our discussion, the basic ideas we have described can be applied to bell-and-spigot plumbing. Comparing the approach used for bolted-flange to the approach used for bell-and-spigot illustrates the generality of the method, and makes it clear that the basic idea of these leak-control devices has its roots in certain abstract principles of connectivity and containment which it is our intent to include within the scope of the present invention.

### Phases of Fastening

Even within a single convention or “family” of plumbing devices, there can be different kinds of fastening and different phases of fastening which may need to be distinguished. For example, in the bolted-flange plumbing convention, a bare pipe may be welded onto, or screwed into a flange at one or both ends of that pipe. We will call this attachment step “pre-attachment”. Once this is done, the pipe, now equipped with one or more flanges, may then be attached by bolting one of its flanges onto another device equipped with a matching flange. We will call this attachment step “field attachment”.

For a general plumbing family, pre-attachment is the attachment, to a bare pipe, of the fittings necessary so that the pipe can then participate in the joining convention of that family. Field attachment is the attachment of a pipe or similar object equipped with those fittings to another such object which has matching fittings.

Some plumbing families don't require a pre-attachment step. For example, in some forms of bell-and-spigot, the bell or the spigot shape is directly cast into the pipe, and ready to use without adding other devices. Other forms of bell-and-spigot do require a pre-attachment step. For example, some have steel rings or rubber gaskets which are attached to cast concrete shapes, in order to create the proper bell and spigot fittings.

When words such as joining, attachment, connection, etc., are used in the claims to be set forth below, it will usually be clear from context whether pre-attachment or field attachment is intended. Also, in some instances, because of the generality of the language, both interpretations may be meaningful. However, in cases where it may be necessary to make the distinction between these two phases or modes of attachment, we may use the terms pre-attachment and/or field-attachment to clarify what is intended.

### Connection-Scheme-Independent Description

It is intuitively clear that the ideas of the present invention can be applied in a general way which is relatively independent of the particular connection scheme used in a given family of plumbing devices. We have already seen how these ideas apply to bolted-flange plumbing, and to bell-and-spigot plumbing. However, one can easily see that these same concepts could be readily applied to plumbing with other joining conventions as well.

In what follows, we will describe a few examples. First, imagine a way of connecting pipes with flanges where the flanges are bolted together by means of holes, but, instead of being flat surfaces normal to the axis of the pipes, the flanges are tilted with respect to that axis, forming a truncated cone-like surface which may be either convex or concave. When joining two pipes fitted with these kind of flanges, a convex flange must be inserted into a concave flange. Once the flanges are aligned, nuts and bolts are put in place to tighten the joint.

This hypothetical plumbing convention might be called “swept-flange” plumbing in analogy with swept-wing aircraft. Unlike normal bolted-flange plumbing, it has a gender distinction, similar in its effect to that found in bell-and-spigot. However, an examination of the figures we have presented for both bolted-flange and bell-and-spigot will reveal that our basic ideas would apply with very little adjustment to the swept-flange convention.

For our second example, imagine a gender-neutral way of connecting reinforced concrete pipe, by means of simple butt-joints sealed with a strong, somewhat flexible glue or resin. (Some buildings actually use interlocking reinforced concrete beams held together in a similar way. The Harvard University Science Center, built in 1973, and designed by the Catalan architect Josep Lluis Sert, is one notable example.) Again here, an examination of our figures will show that such a plumbing convention would support the redundant connection devices we have presented.

Another instructive example is the joining convention used for copper pipe in typical household plumbing. This can be viewed as a variant of bell-and-spigot plumbing, one in which a bare piece of cut pipe effectively has spigot connection capacity at both ends, while adaptors, such as elbows, tees, and collars, have bell connections on all their ports. In order to create joints, bare pipes are inserted into the bell flares on the adaptors, and fastened with solder. (It is worth noting that, in the terminology of a previous section, the joints of this convention do not require a pre-attachment step.)

It is clear that a ring-shaped copper fixture, similar to the extended adaptor ring 94, could be made so as to provide the redundant connection capacity of the devices we have presented. For example, this fixture could consist of (1) a short copper collar, with two bell ends, this collar being of the kind normally used to join two copper pipes, and (2) an extending annulus of copper with another such double-bell-ended collar, this one of larger diameter, attached to its outer circumference. This larger collar would surround the smaller collar, and provide an attachment site for a containment cap.

With these examples in mind, it is our intention, in the claims set forth below, to describe our invention in a way that is relatively independent of the plumbing connection scheme being used. To this end, we here introduce some general terminology which we may use to describe the connection elements of plumbing joints. By a “valence feature” we will mean the part or portion of a plumbing fixture that actually seals with a matching such feature in a second plumbing fixture to which the first is connected. Valence features may or may not have a gender distinction. If they do have a gender distinction, then matching valence features will be of opposite gender.

### Pipes and Pipe-Like Objects

In our examples, we have usually spoken of a joint as something that connects a riser pipe to a BOP. However, the method we have described can in principle work without major modification when two pipes are connected (as in the bell-and-spigot examples), or when any two devices with pipe-like connection features are connected. The primary requirements for the success of the method are, for each of these two devices, as follows:
(p 1) The device attaches to the connection fixtures in the same way that a pipe does.
(p2) In the event of an emergency, there is some means of cutting away or otherwise removing enough of the device so that the cap will fit over what remains of it.
(p3) The connection fixtures, even after such removal has taken place, will still have adequate mechanical support.

Provided these conditions hold, the method of the present invention will apply. We will refer to objects which satisfy condition (p1) as “pipe-like objects” in the claims to be set forth below.

### Optional Parts of the Devices

Certain parts which have appeared in many of our examples may not be necessary, under certain conditions, to the function of the devices described. For example, our flanges include shafts (parts 24 and 29) and support collars (parts 30 and 34), even though neither of these parts is strictly necessary. Normally, a pipe would be attached to the shaft of a flange by welding, or by screwing a threaded pipe into a threaded shaft. However, in some applications a pipe can simply be welded directly onto the flange plate 27, without the need for a shaft. Similarly, while support collars do provide extra mechanical strength to a flange fixture, in some applications, support collars are not needed.

### Protection for Both Sides of the Joint

When it is used on the top joint of a BOP, the purpose of the extended flange device is to protect against damage to the riser pipe, or to the top fixture of the joint. In general, however, the device can be used, if desired, to protect pipes on both sides of the joint. Imagine an extended flange joint being used to connect two pipes. If either one of the two pipes breaks or leaks, the outer connection ring of the extended flange can in principle be used to cap the side of the joint to which that pipe is connected. The reason for this is that the connection features found on the extended plate 37 of the extended flange device 36 will work just as well if the cap is attached to the reverse side of the plate, this generally being the underside in our drawings. The outer ring of holes have the right spacing to attach the cap from either side, and the necessary clearance provided by the adaptor space is also present on both sides. Looking at FIG. 6, it is clear that the cap shown in FIGS. 11 and 12 could be attached to either side of the extended plate 37. Examination of FIG. 9 will confirm that this is also true for the extended adaptor plate 46 when it is installed in a joint like the one shown in FIG. 9.

In order for this reversibility to work, the pattern of holes in the outer ring must be self-symmetric by reflection (as in a mirror) through some plane containing the cylindrical axis of symmetry of the device. However, in the preferred implementation, these holes will be spaced at regular angular intervals on a circle in the plane of the flange, with the center of that circle being on the cylindrical axis. Under these conditions, the required symmetry of reflection will be present.

Even when the pattern of holes isn't mirror symmetric, two-sided connective capability can also be achieved by putting two sets of holes into the plate, one for use on one side and another set for use on the other side, and possibly some holes which can be used on either side. If this approach is chosen, the holes must be properly spaced so that they are not too close together, since that might weaken the plate. We won't go into the details of this option, however, or the spacing which it would require.

Of course, whichever side is capped, the pipe or pipe-like object on the capped side of the fixture must still be cut to a length short enough so that the cap is big enough to enclose it, unless it is already short enough as a result of damage sustained in an accident.

The same double-sided coverage possible in the bolted-flange context can also be achieved in the bell-and-spigot environment. There, the situation is a bit more complex than in the bolted-flange plumbing standard, because, unlike a sheet of material with symmetric holes, a bell ring or a spigot ring may not support the same kind of connection on both sides of the material of which it is made. However, as we saw in our discussion of FIG. 16, it would not be hard to add a second ring of material, similar to the extension connector 95C, but on the opposite side of the extended adaptor ring 94, in the position marked 95D in FIG. 16. With this modification, the extended adaptor ring can now be used from either side, and indeed it will support both bell and spigot caps, from either side, as well. Moreover, comparing FIG. 16 with FIG. 14A, it is clear that the same modification could also be made on the extended ring pipe, allowing it to support emergency capping from either side as well. Capping the extended ring pipe from the “pipe side” (the left side in FIG. 14A) might of course require cutting the ring pipe's pipe-like portion 92P down to make it short enough to fit into the cap.

As explained in a previous section, the remarks here about two-sided protection for connected pipes would also apply to connected pipe-like objects.

### Shape-Equivalent Embodiments

In describing the scope of the present invention, it is convenient to notice that, both in the bolted-flange and in the bell-and-spigot plumbing standards, the devices we describe can be embodied in different ways which yield an equivalent shape, and thus also an equivalent redundant connection functionality.

For example, FIGS. 5 and 6 show an assembled plumbing joint made from the extended flange 36, while FIGS. 8 and 9 show an assembled plumbing joint made from the extended adaptor plate 46. It is clear from these figures that the extended flange 36 has a similar shape to what one would obtain by putting an extended adaptor plate 46 on top of a prior art flange 20, and then somehow fusing the adaptor plate 46 onto the top plate 21 of the prior art flange. These two shapes would not be identical, but they provide the same connective capability from the top, and from the bottom as well, as it happens.

A similar situation occurs with bell-and-spigot devices. Comparing FIG. 14A with FIG. 16, we see two combinations which have nearly identical shapes, and which provide essentially equivalent connection capacity. In order to avoid unnecessary repetition in the claims to be set forth below, we would like to here introduce some terminology that can be used to describe devices of similar shape.

We will illustrate this terminology by example, as follows. The extended ring pipe 92 seen in FIG. 14A can be described as a “union” of the extended adaptor ring 94, and the inflow pipe 90, both shown in FIG. 16. The term union, borrowed from set theory, is meant to suggest what is obvious to the eye, namely that the extended ring pipe, while it may actually be formed from a single piece of reinforced concrete, has the same shape one would obtain by fusing the extended adaptor ring with the inflow pipe which is connected to that ring in FIG. 16.

With this terminology, we can then describe the extended flange 36 as a union of the extended adaptor plate 46 with a particular portion of the prior art flange 20, that portion being all of the prior art flange except its top plate 21. This portion of the prior art flange 20 will be referred to as the “support base” of the prior art flange. Since the support base is simply a specific combination of named parts already seen in various drawings, it will be clear from our definition what the support base is without showing it in a figure.

In effect what we are saying is that if you were to remove the top plate from a prior art flange, and replace it with an extended adaptor plate 46, you would get an object with the same shape and properties as the extended flange 36.

Another way to think about this is to view the adaptor plate 46 as being the basic device, and the extended flange 36 as being this basic device with a part added, that part being the support base. The support base consists of the shaft and the support collar, which, as we have seen in a previous section, may be optional features in some applications. Thus the support base itself can be thought of as an optional feature.

Just to be clear, describing an object as a union, in the sense we have defined here, is only meant to describe its shape, not how it was actually manufactured. So, for example, an 8-foot section of reinforced concrete pipe can be described in shape terms as a union of two adjacent 4-foot sections of such pipe, even though the 8-foot section may not have been manufactured by joining two 4-foot sections.

This separation of shape-description from manufacturing description makes sense in our situation, because the redundant connection capacity of the devices we describe depends primarily on their shape, not on how that shape was achieved.

In the claims to be set forth below, we may find that the use of this concept of union allows for a clearer and more concise presentation of the claimed content of the present invention.

What is claimed is:

1. An extended-flange plumbing fixture kit, for use with standard bolted-flange plumbing fixtures, and with pipe-like objects to which they may be connected, this kit comprising:
i. an extended-flange plumbing fixture, said fixture comprising
a. a plumbing flange connector, with its usual flange plate for connecting to another such flange device,
b. an extended annular ring of material, included as part of said plumbing fixture by means of one of the following two methods of construction:
1. said ring shall be co-extensive with, and continuously extending the material of the flange plate of said plumbing flange connector, the resulting connector, so extended, being here referred to as an “extended flange connector”, or
2. said ring shall be the outer portion of a separate disk of material, here referred to as an “extended adaptor plate”, placed on top of the flange plate of said plumbing flange connector, said disk also being equipped with an inner ring of holes matching the holes in said flange plate, so that said disk may be sandwiched and fastened with bolts between said plumbing flange connector and a matching plumbing flange connector so as to produce a 3-part installed configuration,
c. an extended connection feature, such as an outer ring of holes, in said extended annular ring, these holes being suited for joining with a pipe flange connector similar to that of the standard flange, but possibly of a larger diameter, and
d. a clearance space, here referred to as the “adaptor space” between the outer ring of holes and the outer boundary of the standard flange, this space being of an extent sufficient to provide adequate clearance so that a suitable pipe-like device can be properly mounted on the extended connection feature,
and
ii. a matching containment cap, here referred to as the “transition adaptor”, equipped with a flange which matches said extended connection feature, so that said cap may in the event of an emergency be attached to said connection feature in a fluid-tight way,
such that, in consequence of such composition, said extended-flange plumbing fixture provides a reserve or back-up connection capacity by which, as part of a protective procedure, an installed plumbing joint including said extended-flange plumbing fixture may be fitted with said containment cap, such attachment serving to seal or contain a leak resulting from damage to one of the two pipe-like devices attached to said installed plumbing joint.

2. The extended-flange plumbing fixture kit of claim 1, wherein the matching containment cap of that claim is a device manufactured so as to fit onto the extended connection feature of that claim, in the context of an installed plumbing joint which includes the extended-flange plumbing fixture of that claim, said installed plumbing joint being here referred to as the “target joint”, and said cap comprising the following elements:
a. a containment device connection feature matching the extended connection feature of said target joint, in such a way that the two connection features can be joined in a fluid-tight manner, this extended connection feature being provided by said target joint's included extended-flange plumbing fixture,
b. an enclosure structure which, except for intentionally provided ports and openings, allows no fluid to escape from the enclosure region which it envelopes, and
c. an optional extraction port, and an optional plurality of other accessory ports, allowing for the extraction of fluids from or the insertion of fluids into the enclosure region enclosed by said enclosure structure, and also allowing for measuring devices or other equipment to be inserted into or removed from the enclosure region,
such that, in consequence of the inclusion of such elements, it is possible, in the event of an emergency in which a pipe-like object connected to said target joint is damaged, to perform attachment of said cap to said extended-flange plumbing fixture, provided that said damaged pipe-like object has been previously cut to a sufficiently short length, such attachment providing the capacity to block or extract fluid which may be leaking from said pipe-like object, and to achieve such blockage or extraction without taking apart said target joint.

3. The extended-flange plumbing fixture kit of claim 1, wherein the protective procedure mentioned in that claim is here further described as a method or process whereby a plumbing joint may be provided with a form of redundant connection capacity so that, in the event that a break or leak occurs downstream from said joint, the flow from this break or leak may be contained without the need to disassemble said joint, said method having the following steps:
a. said joint, either when first assembled, or as a result of disassembly and later reassembly, is built and configured by one of the two methods of construction described in claim 1, so as to include an extended-flange plumbing fixture as described in claim 1,
b. a cap is manufactured or obtained, with a connection feature matching the connection feature of the extended-flange plumbing fixture included in said joint, this cap then being placed in storage for use in the event of an emergency,
c. if and when an emergency does occur, and in such emergency the outflow pipe-like device of said joint breaks or leaks, said device here being referred to as the “outflow carrier”, then, at such time, a fluid containment response will be undertaken, having the following steps:
i. a portion of the outflow carrier shall be cut off, or otherwise removed, so that the remaining length of said carrier will fit inside of said cap, leaving adequate clearance between the end of said carrier and the various ports of said cap so as to allow those ports to fulfill their intended functions, and
ii. said cap, or another suitable cap, shall be retrieved from storage, or otherwise obtained, and installed over said joint in the manner described in claim 1,
and
d. once a cap has been so installed, other fluid containment, control, or measurement devices may then be optionally attached to the various ports of the installed cap,
such that, in consequence of these steps, a result is obtained whereby standard fixtures or devices may be attached to the resulting assembled fixture, and used to capture, block, or extract the leaking fluid, without the need to disassemble said plumbing joint in order to obtain this result.

4. The extended flange plumbing fixture kit of claim 1, further including a protective device here referred to as the “extended flange protection unit”, said device comprising:
a. a protective cage similar to one or more roll-bars, these roll-bars possibly being interconnected, this cage being placed over and also possibly around the extended annular ring described in claim 1, and
b. an annular cushion ring, possibly divided into a plurality of separate portions, these portions being placed within said protective cage, these portions also being placed over and possibly around said annular ring,
so that said extended annular ring will, as a result of the presence of said cage and said cushion ring, be protected from damaging impacts in the event of an accident or emergency.

5. The extended flange plumbing fixture kit of claim 1, wherein the extended annular ring of that claim, being part of an extended flange plumbing fixture also described in that claim, is constructed according to method 2 of that claim, said ring being the outer portion of an extended adaptor plate, with this plate having the following features:
a. a central flow opening of approximately the same diameter as the inner diameter of the pipe-like objects to be connected to said extended flange plumbing fixture,
b. an inner ring of holes, arranged with their centers approximately along a circle, these centers having regular angular spacing around the center of that circle, these holes being of such a diameter and pattern of placement as to align with the holes in a standard bolted-flange plumbing fixture of comparable size, and
c. an outer ring of holes, arranged with their centers approximately along a larger circle, these centers having regular angular spacing around the center of that larger circle, with this larger circle also being approximately concentric with the smaller circle whose circumference passes approximately through the centers of said inner ring of holes, said outer ring of holes being of such a diameter and pattern of placement as to align with the holes in a standard bolted-flange plumbing fixture of comparable size, such as the attachment flange of a containment cap,
so that, in consequence of such features, said extended adaptor plate may be sandwiched in a 3-part joint between two plumbing flanges with holes matching the inner ring of holes of said plate, said joint then being fastened with bolts of suitable length passing through the holes of said inner ring of holes, the result being that, in the event of a leak from one of the pipe-like objects attached to said joint, a suitable containment cap may be attached in a fluid-tight manner to the outer ring of holes of said plate.

6. The extended flange plumbing fixture kit of claim 1, wherein the extended annular ring of that claim, being part of an extended flange plumbing fixture also described in that claim, is constructed according to method 1 of that claim, said ring being the outer portion of the flange plate of an extended flange connector, with this extended flange connector having the following features:
a. a central flow opening of approximately the same diameter as the inner diameter of the pipe-like objects to be connected to said extended flange plumbing fixture,
b. an inner ring of holes, arranged with their centers approximately along a circle, these centers having regular angular spacing around the center of that circle, these holes being of such a diameter and pattern of placement as to align with the holes in a standard bolted-flange plumbing fixture of comparable size, and
c. an outer ring of holes, arranged with their centers approximately along a larger circle, those centers having regular angular spacing around the center of that larger circle, with this larger circle also being approximately concentric with the smaller circle whose circumference passes approximately through the centers of said inner ring of holes, said outer ring of holes being of such a diameter and pattern of placement as to align with the holes in a standard bolted-flange plumbing fixture of comparable size, such as the attachment flange of a containment cap,
so that, in consequence of such features, said extended flange connector may be combined with a plumbing flange, this plumbing flange having holes matching the inner ring of holes of said extended flange connector, such combination producing a 2-part plumbing joint, said joint then being fastened with bolts of suitable length passing through the holes of said inner ring of holes, the result being that, in the event of a leak from one of the pipe-like objects attached to said joint, a suitable containment cap may be attached in a fluid-tight manner to the outer ring of holes of said extended flange connector.

7. A redundant adaptor ring for use within a particular predetermined and selected member of a class of plumbing families, this class including, but not limited to, the class of bolted-flange plumbing families and the class of bell-and-spigot plumbing families, said redundant adaptor ring, in its respective embodiments within the two here-named classes of plumbing families being referred to as an “extended adaptor plate” or an “extended adaptor ring”, respectively, and said redundant adaptor ring being equipped with the following elements:
a. one or more inner valence features on one or two of the sides of said ring, said valence features allowing said ring to be connected in a 3-part fixture between two pipe-like devices from the selected plumbing family,
b. a continuous annular body of material extending outward from the outer boundary of the inner valence features of said ring, this body including, on one or both sides of itself, one or more outer valence features, these features being so arranged that a pipe-like device can be attached to one of said outer valence features, said pipe-like device being of a larger diameter than one which would fit the inner valence features of said ring,
such that, in consequence of its shape, said redundant adaptor ring provides a reserve or back-up connection capability by which, as part of a risk-management procedure, an installed plumbing joint including said ring may be fitted with a containment cap which attaches, using a pipe-like fitting, to one of the outer valence features of said ring, facilitating the sealing, extraction, or containment of a leak from one of the two pipe-like objects connected by said joint, without the need to disassemble said joint in order to obtain this result.

8. The redundant adaptor ring of claim 7, wherein each of the valence features is optionally arranged geometrically along a simple closed curve, such as a circle, square, or oval, with such curves, if present for both the inner and outer valence features, being optionally concentric.

9. The redundant adaptor ring of claim 7, further including a pipe-like object joined to one of the inner valence features of said ring, such joining being either by attachment or by union, and such joining optionally also further including a support base, the effect of such joining being that this included pipe-like object, by virtue of its joining to said adaptor ring, now has similar redundant connection properties to those provided by said ring, as described in claim 7.
